(19) United States
(12) Patent Application Publication
(10) Pub. No.: US 2002/0138728 A1
(43) Pub. Date: Sep. 26, 2002

(54) Method and system for unified login and authentication

(76) Inventors: Alex Parfenov, Mableton, GA (US); Mikell S. Mitchell, Atlanta, GA (US); Jack Zheng, Duluth, GA (US); Rolf Hunt, Marietta, GA (US)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(21) Appl. No.: 09/799,810

(22) Filed: Mar. 6, 2001

Related U.S. Application Data
(60) Provisional application No. 60/187,617, filed on Mar. 7, 2000.
(60) Provisional application No. 60/223,944, filed on Aug. 9, 2000.

(51) Int. Cl. H04K 1/00; H04L 9/00

(52) U.S. Cl. 713/170; 713/153; 713/154; 713/155; 713/161; 713/182

(57) ABSTRACT

A unified login and authentication method and system for logging into one or more of a plurality of hosts over a global computer network. The system uses a triangular arrangement, wherein the three vertices comprise an affiliate service provider that performs partial authentication, a central hub for providing partial authentication of a client, which is the third vertex. The hub processes login credentials, creates a token to establish a session, and encrypts the credentials into separate messages. The affiliate receives the messages from separate channels, decrypts them, and compares the credentials from one message to another. If the credentials match, access is granted to the affiliate resources. Secure Internet protocol is used for communications between each of the three primary computer nodes. The hub and each affiliate use digital certificate technology to communicate between the backend of each node. The hub does not respond to requests received at its backend.

### CROSS REFERENCE TO RELATED APPLICATIONS

This application claims priority under 35 U.S.C. §119(e) to U.S. Provisional Application No. 60/187,617 entitled “Unified Login And Authentication System” filed on Mar. 7, 2000, and to U.S. Provisional Application No. 60/223,944 entitled “Unified Login Using URL” filed Aug. 9, 2000.

### FIELD OF THE INVENTION

The present invention relates generally to a computer access control system, and, more particularly to a method for accessing a plurality of secure web sites using a single login identification.

### BACKGROUND

Using the Internet for Electronic commerce (“e-commerce”) has produced many gains in efficiency and productivity. Buyers and sellers can transact business without physically having to leave their place of business. Although commerce may be conducted using a telephone, fax machine, or traditional mail services to communicate transactions between merchants, the convenience of such transactions is limited inasmuch as purchasers have to place orders when a vendor, or other provider of goods and services such as the government, is open for business and employees are at work. Thus, e-commerce provides greater convenience because a buyer can place an order at anytime, day or night, using a vendor's Internet web site. The vendor's computer system can then process the order automatically, print shipping labels and invoices, and in some cases even deliver the product automatically. This is especially true when the product is information, such as software, music, video, or other electronic content that is easily transferred digitally over the Internet. In order to facilitate such automation, a buyer typically uses a credit card number, or other account number, which can be verified automatically by the seller before shipping the product.

Whether the product is deliverable over the Internet or must be physically shipped to the buyer, the seller may maintain a profile of each customer. Such a profile is maintained for buyers that have authorized the seller to maintain such information, where the profile includes account number, shipping address, customer name and other information related to the buyer. To encourage a buyer to reveal such sensitive information, he or she must have reasonable assurances that the information will be kept private from others. This is especially true for an account number, for if an unscrupulous individual had access to the buyer's account number, he or she could purchase products from the seller and charge the cost to a customer's account. Thus, it is desirable to protect the transfer of sensitive information between buyers and sellers, or others that wish to exchange sensitive information. In addition, it is desirable to protect the sensitive information once it has been entrusted to a vendor.

Therefore, many methods, protocols and products for preventing unauthorized detection of sensitive information that passes between network-connected computers, sometimes referred to as nodes or hosts of the network, have been devised. These methods, protocols and products are well known in the art and have been used for a number of years to protect sensitive information from interception while in transit, or when stored on an Internet computer system. These methods include encryption and other mathematical algorithms for garbling data, so that unless an individual possesses a key for deciphering the data, it will be incomprehensible.

One such method is Secure Sockets Layer (“SSL”), a commonly used protocol for managing the security of a message transmission on the Internet. SSL uses a program layer located between the Internet's Hypertext Transfer Protocol (“HTTP”) and Transport Control Protocol (“TCP”) layers of a typical Internet Browser. SSL was developed by Netscape, Inc. and is included as part of most Internet server products and browsers made by various manufacturers; most notably those made by Microsoft, Inc. and Netscape, Inc. The result of using SSL for communications between Internet browsers and Internet servers is known as Hypertext Transfer Protocol Secure (“HTTPS”).

The “sockets” part of the term SSL refers to the sockets method of passing data back and forth between a client and a server program in a network, or between program layers in the same computer. A socket is defined as the endpoint in a connection, and may be created and used with a set of programming requests or function calls sometimes called the sockets application programming interface.

A computer browser operating in SSL mode uses a public-and-private key encryption system, which includes the use of a digital certificate to certify that a computer sending a digital message is the computer it says it is. Thus, a message encrypted with the receiving computer's public key is viewed as legitimate by the receiving computer. Conversely, a message surreptitiously intercepted and redirected by another computer to the receiving computer will be viewed by the receiving computer as illegitimate.

Accordingly, many vendors that offer their wares over the Internet use SSL, or some similar protocol arrangement that provides similar benefits as SSL, to protect their Internet web sites that involve the transfer of sensitive information. Such a web site is often referred to as a secure resource, because of the added security that SSL provides over standard HTTP Internet protocol.

Although the security techniques discussed above have alleviated many of the fears concerning the use of the Internet for sending and receiving sensitive information, the competitive nature of business demands more than just security. As discussed above, the Internet provides greater convenience than more traditional methods of performing transactions, accessing sensitive and not-so-sensitive information, and even providing access to executable software. Thus, a typical business entity, or even consumer, may have a variety of goods and services that are fulfilled using the Internet

While the goods or services of interest may vary greatly depending upon the needs of a particular business or interests of a consumer, a smaller core of vendors may fulfill the needs of many merchants or consumers. These core vendors may be thought of as related, or affiliated with one another, inasmuch as they provide goods or services that are desired by a broad range of consumers or business entities.

For instance, a restaurant may obtain vegetables from a particular vendor, paper products from another, and grill equipment from yet another. If the restaurant owner or manager places orders for such items over the Internet, that order-placer has to access the web site of each of the vendors to place an order for the respective goods or services. Therefore, if the restaurant purchases goods via the Internet on a regular basis, it typically will have an account set up with each of the on-line vendors.

To facilitate such an e-commerce scenario, each vendor's web site server typically has a profile of the restaurant stored on a database to facilitate order fulfillment. In accordance with known computer security procedures, the vendor's web site will typically require submission of identification credentials before granting access, known as logging in, to the secure web site resources that contain profile and other sensitive information. These credentials typically comprise a login name and password, where each is associated with the buyer's account profile.

The credentials are typically established when a user, either a merchant or a consumer, registers with a vendor's web site. The “registration” process typically comprises the user entering profile information into a user interface generated by the vendor's computer server, and, when the information has been entered, either the user or the vendor's computer server selects a user login name and a user password that serve as the login credentials. Upon submission of the profile information and login credentials, the user is “registered”

Upon registration and any time thereafter, a buyer may then order goods or services, which are automatically charged to the account associated with the credentials used to initiate the purchasing session. This is done without having to enter the profile information each time an order is placed. Furthermore, the vendor's computer server does not have to re-verify that the buyer actually has an account set up with the particular vendor each time the user attempts to access the vendor's secure resource. Thus, the convenience of Internet e-commerce is enhanced.

Although ordering goods and/or services using the Internet is more convenient than doing so using more traditional methods, a buyer still must log in to each secure web site resource from which a purchase is to be made. This is true even if a buyer's profile information is associated with login credentials. Furthermore, each vendor's web site may have different requirements for the login name and password credentials.

Accordingly, a person placing orders must maintain a list of identification information, e.g. login name and password, for all the various vendor web sites that the restaurant may wish to access. If the keeper of the list is replaced, and does not provide the list of identification information to his or her replacement, the process of establishing new identification information for each vendor site may have to be repeated. In addition, access to each vendor's secure resources typically requires a separate login event, which increases the time required to place each order. This is because each vendor's Internet computer server must receive login credentials, perform various database lookup routines to verify the credentials and profile information, and perform state management by establishing a session between the buyer and the vendor.

Thus, there is a need in the art to provide a secure method and system of accessing a plurality of secure affiliated web site resources using a single identifier, such as one login name and one password. This method should not allow unauthorized access to the secure site resources, or the dissemination of sensitive information to an unauthorized entity. Otherwise, a would-be affiliate will be reluctant to become part of a system that implements such a method. Furthermore, because consumers and especially merchants have become accustom to “having it now”, there is a need for this method to be fast enough to process and confirm the requested action on-line without undue delay.

In addition, there is a need for such a method and system to be transparent to a user. Such a transparent system would provide a seamless transition from one secure resource to another after having once entered the login name and password. Furthermore, a user would not be required to enter the login name and password every time a user attempts to access a vendor's secure resource.

Finally, the method and system should be adaptable for use over different types of networks.

### SUMMARY OF THE INVENTION

The present invention provides a unified login and authentication (“ULA”) system that allows a user to migrate from one affiliated vendor to another without requiring an additional login. The ULA system employs existing world wide web (“www”) technologies and does not require plug-ins or client applications or client-side certificates.

A ULA system utilizes a zero-trust (or minimal trust) triangle architecture between three components. These components are a user's computer (“client”), a central implementation computer server (“hub”), and one or more vendor computer servers (“affiliate” or “affiliates” respectively). Unlike other single-sign-on solutions, the ULA system does not merely proxy the user's login. Rather, the ULA system splits a client's identification into two different formats, and passes them in the form of XML message tokens over two separate channels: hub-to-affiliate and client-to-affiliate. Moreover, one message is of no use without the other because neither can be fully decoded such that useful information can be extracted without the other message. Thus, even if one of the messages is intercepted, the credential information cannot be extracted in a useful format such that the credentials may be used to gain unauthorized access to an affiliate's secure resources.

The ULA system employs industry-standard Internet and cryptographic technologies to protect the user's credentials in transit. These technologies include HTTP and HTTPS, Extensible Markup Language (“XML”) messaging, SSL, digital certificates, tokens, and cookies. The term token is used to generically refer to a packet of information or data sent from one network computer to another. A token may be used to send parameters or variables from one computer to another and typically contain information for future use. A cookie is a particular type of token for providing information in the future to a sending computer about a computer that receives and stores the cookie. Use of these technologies are well known to those skilled in the art.

In the preferred embodiment, communications between the client, hub, and affiliate utilize SSL capability. In addition, communications between the hub and the affiliate use certificates, such as X.509, so that each node receiving a message from the other is assured that the other is who it indicates it is. The certificates are issued by a certificate authority (“CA”), and use the SSL capability of the hub-affiliate connection. Use of certificates is known to those skilled in the art.

A user may access affiliates with which the user is registered by either attempting to access any one of the registered affiliates, or by logging into the hub first. A token, or cookie, is used to electronically document that a session has been established between a particular client and the hub. Thus, after a session has been established, and for as long as it is active, the client may access all the secure affiliates that are registered with the hub without having to enter login credentials again. Such access may be achieved by first accessing and logging into the hub, and then requesting that the hub direct the client to the secure resources of an affiliate selected by the user. Alternatively, the user may attempt to access one of the secure resources of one of the affiliates directly. For example, this may occur when a user uses a bookmark saved in the client browser from a previous session. The client is then redirected to the hub, whereupon the hub determines whether a token exists. If a hub-client session token exists, the ULA system electronically conveys to the affiliate that the client should be granted access to the selected affiliate, and redirects the client to the affiliate.

If the hub determines that the client is not already logged in, the hub requests and receives user login and password credentials from the client. The hub then queries a database that associates the user's credentials with the user's sequential identification (“UID”). An UID exists for each user registered with hub, and is created as each new user registers with the hub. If the database contains an entry for the received login and password, the query returns the associated UID and the hub uses XML messaging functionality to send the associated UID to the selected affiliate.

The UID is then sent to the affiliate in a pair of messages: a first message directly from the hub for providing the UID and a timeout instruction, and a second message from the hub by way of a redirect function to the client for providing the UID in a different format that is useless without information from the first message. The first message is preferably an XML message sent from a one-way socket to the selected affiliate at a back-end address of the affiliate, which also uses XML messaging functionality. The one-way socket is part of the hub, but the hub does not perform actions in response to messages that arrive at this socket unless such a message is responsive to a request initiated by the hub. Thus, the hub cannot be controlled by another node of the Internet unless that node is responding to a request and message sent to that node by the hub.

After sending the first message, the hub sends a second message to the affiliate as it redirects the client to the affiliate at a front-end address. As discussed above, the two different messages provide the UID in different formats so that if one is surreptitiously intercepted, it is useless without the other. In addition, the low likelihood that the two messages received at different addresses come from an imposter provides added assurance that the client is legitimate.

The UID sent in each message is modified using standard cryptography techniques. These techniques include private key cipher algorithms and hash function algorithms. In the cryptography arts, a private key is a secret encryption/decryption key known only to the party or parties that exchange secret messages. In traditional secret key cryptography, a key would be shared by the communicators so that each could encrypt and decrypt messages. This is sometime referred to as symmetric key cryptography because the same key used to encrypt a message is used to decrypt it. The cipher techniques used in the preferred embodiment of the present invention use cipher and hash algorithms that are known in the art.

As discussed above, each of the two messages contain the UID, but in different formats. In addition, each message contains a private cryptographic key used to decrypt information in the other message. The first message sent to the affiliate contains a random number generated by the hub, the UID encrypted with a first randomly generated key, a second randomly generated key, and a timeout instruction. The second message contains the same random number that was sent in the first message and an intermediate data packet. The intermediate data packet contains a hashed version of the UID and the first, randomly generated key. The intermediate data packet is encrypted with a second randomly generated key. This encrypted intermediate data packet becomes the second message. Thus, the affiliate has two messages received from the hub at different times and from different channels, wherein the messages correspond to the same client and that particular client's login request.

The affiliate may receive many first messages and second messages during the interval between receiving the first message and second message for a given client. This scenario may occur when many clients are attempting to log in to a particular affiliate during a certain window of time. In order to match the first message to the second message, the random number from the second message is used to determine which first message matches the particular second message being considered by the affiliate.

After the first message has been matched to the second message using the random number, the second key is extracted from the first message and used to decrypt the intermediate data packet from the second message. Next, the affiliate extracts the first key from the intermediate data packet and uses it to decrypt the UID from the first message. The hub then performs a hash routine on the UID decrypted from the first message. If the hashed UID from the first message matches the hashed UID decrypted from the second message, the affiliate is assured that the client is a valid user and is who they say they are. Thus, the present invention effectively authenticates a client to an affiliate. Authentication is achieved because of the low likelihood of receiving separate messages at different times and different addresses, with the UID of one message matching the UID of the in the other. Moreover, because the key received in one message is required to decrypt information in the second message, the level of assurance provided to the affiliate is even greater.

Finally, the timeout instruction in the first message serves to reduce the possibility that a would-be hacker, who may have appropriated the second, randomly generated key, will be able to log into the system as an authenticated user. Such a hacker may have enormous computing resources capable of determining the hash function.

For example, in the field of encryption, organizations often sponsor events where individuals or groups are invited to try to determine an input string by inverting a hash value. These attempts typically use many computers linked together through a network to share computing resources and attempt to determine the input to the hash function. Although these events typically result in one entrant or another figuring out a particular hash input value, it always takes a certain amount of time to do so. Thus, since the entrants to such an event are typically some of the worlds most capable computer scientists, this empirically derived information may be reasonably established as the shortest amount of time required to determine an unknown hash function.

Accordingly, the present invention may make use of such a predetermined amount of time in establishing the value of the timeout instruction. Thus, a timeout instruction so established is used to cause the ULA system to expire before a hacker can determine the hash input value. If the timeout instruction does not expire the process of comparing the UID in one message to the UID in the other, the affiliate is further assured that the redirected client is properly associated with the UID contained in each of the two messages. Therefore, it will be appreciated that the timeout instruction is one example of the multiple levels of security for authenticating a client before granting that client access to the affiliate's secure resources.

In addition, the SSL and certificate functionality provides secure communications between the backend addresses of communications channel between the hub and the affiliate. This provides a reasonable level of assurance that neither the hub nor the affiliate can be accessed and controlled from their respective backend connections by another node. Thus, a client must always access an affiliate through the front-end of the affiliate. Furthermore, even if an affiliate is somehow corruptly accessed, because the hub backend address does not respond to non-requested messages from another node, the corruptly accessed affiliate will not provide a means for corruptly accessing other affiliates via the hub.

It will be appreciated that although the preferred embodiment uses private key cryptography techniques, a version of the ULA system that does not uses private key cryptography may also provide an affiliate reasonable assurance related to authenticating a client. Such a version would still use the hash routines, timeout instruction, and random number for matching the first message to the second message, in addition to the aforementioned SSL, one-way socket and certificate technology.

Generally described, the present invention comprises a system that includes a hub, including means for receiving credentials, means for splitting the credentials into separate messages and means for sending the separate messages separately to an affiliate. The invention further comprises means for receiving the messages and for comparing the credentials from one message to the credentials of the other to determine whether to grant access. The messages may be sent to the affiliate via a backend connection, wherein the backend connection of the hub comprises a secure socket that does not respond to message unless the hub requested the message. The hub may also comprise means for sending and receiving digital certificates via the backend connection.

The system further comprises a plurality of affiliate hardware equipment and software applications, wherein each of the plurality of affiliates includes a server computing means, means for listening for messages, means for secure communications, means for encrypting and decrypting identification messages.

The present invention further comprises a method for accessing a plurality of affiliate nodes comprising the steps of receiving a log-in request, establishing a session token upon successful login, generating a first encrypted hub UID using a first secure random key, sending a first message to said one of the plurality of affiliate nodes, the first message including a first encrypted hub UID, a random number, a second secure random key and a timeout instruction, generating a first hashed hub UID, generating an encrypted intermediate data packet, wherein the intermediate data packet includes the first hashed hub UID and the first secure random key, and sending a second message to said one of the plurality of affiliate nodes, wherein the second message includes the random number and the encrypted intermediate data packet.

The present invention further comprises a method for authenticating access to an affiliate, the method comprising receiving an access request, receiving a first message, wherein the first message includes a first encrypted hub UID, a random number, a second secure random key and a timeout instruction, receiving a second message, wherein the second message includes a random number and an encrypted intermediate data packet, retrieving the first message, wherein the random number of the first message corresponds to the random number of the second message, verifying that the timeout instruction has not expired, decrypting the intermediate data packet using the second secure random key from the first message, decrypting the hub UID from the first message using the first secure random key decrypted from the intermediate data packet, hashing the hub UID decrypted from the first message, comparing the hashed hub UID from the first message to the hashed hub UID from the second message, and granting access, wherein granting access comprises establishing a session token with a client.

The present invention still further comprises a method for accessing an affiliate, the method including the steps of receiving a user interface from a hub, establishing login credentials with the hub, entering the login credentials to gain access to one or more affiliates, receiving a token that establishes a session with a hub, receiving a token that establishes a session with an affiliate, accessing a selected affiliate by selecting a control item that corresponds to the selected affiliate.

In addition, the present invention comprises a method for accessing an affiliate comprising the steps of attempting to access a secure resource of an affiliate, following a redirection instruction to a hub, receiving a user interface from the hub, establishing login credentials with the hub, entering the login credentials to gain access to one or more affiliates, receiving a token that establishes a session with a hub, receiving a token that establishes a session with an affiliate, and accessing a selected affiliate by selecting a control item that corresponds to the selected affiliate.

Other goals, features, and advantages of the present invention will become apparent upon reviewing the following detailed description of the preferred embodiments of the invention, when taken in conjunction with the drawings and the appended claims.

### BRIEF DESCRIPTION OF THE DRAWINGS

FIG. 1 Illustrates a unified login and authentication system.

FIG. 2 Illustrates the components of an affiliate application.

FIG. 3 Illustrates the components of a hub application.

FIG. 4 Illustrates an affiliate database table maintained by a hub for associating an affiliate identification with the affiliate's cipher and hash types, and for storing parameters received from an affiliate.

FIG. 5 Illustrates a client database table maintained by a hub for associating a sequential client UID with a user login and password.

FIG. 6 Illustrates a parameters database table maintained by an affiliate for first and second messages.

FIG. 7 Illustrates an account association database table to associate a ULA client UID with the account number the client has with the affiliate.

FIGS. 8A-8C Illustrate a method for operating a unified login and authentication system.

FIG. 9 Illustrates a method for preparing variables for use with a ULA.

FIG. 10 Illustrates a method for decrypting a second message.

FIG. 11 Illustrates a method for retrieving a sequential UID from a salted UID.

FIG. 12 Illustrates the syntax for a first message.

FIG. 13 Illustrates the syntax for a second message.

FIG. 14 Illustrates a screen shot of a hub home page.

FIG. 15 Illustrates a screen shot of a hub login page.

FIG. 16 Illustrates a screen shot of an account creation page.

FIG. 17 Illustrates a screen shot of a hub selection page for selecting an affiliate.

### DETAILED DESCRIPTION OF THE PREFERRED EMBODIMENT

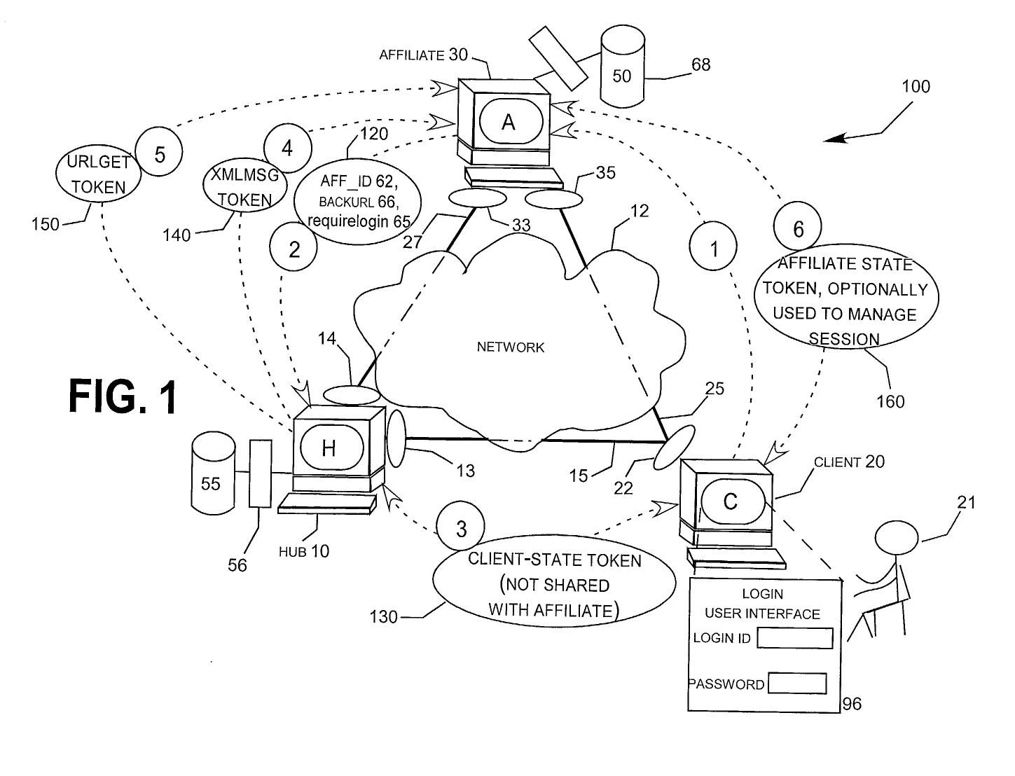

Referring now to the drawings, in which like numerals indicate like components and elements throughout the several drawing figures, FIG. 1 illustrates a ULA system 100 and the primary components for its implementation. The encircled numerals 1-6 indicate major steps of the login process in sequential order according to the present invention. Other numerals indicate components of the system. These items may be either physical components, or virtual components. An example of a virtual component is an electrical signal, such as an XML message, sent over a network, such as the Internet.

The ULA system 100 centers on three primary components connected by a network 12. These components are a hub 10, one of a plurality of clients 20 and one of a plurality of affiliates 30. It will be appreciated that a plurality of clients 20 each may have access to a plurality of affiliates 30. Although only one client 20 and one affiliate 30 are shown in the figure, more clients and affiliates may be simultaneously connected to the ULA system 100. However, for purposes of clarity and example, FIG. 1 only illustrates one client 20 and one affiliate 30.

Each of the three components that are shown in FIG. 1 are connected in an arrangement that forms a triangular architecture. Each component represents computer equipment that connects to a computer communications network 12, such as the Internet, to communicate with other computer equipment connected to the network. Those skilled in the art often refer to one system of computer equipment that connects to the Internet at a single connection point as a node, or sometimes a host. Thus, each vertex of the triangular structure is a node of the Internet 12, which comprises a plurality of nodes that are simultaneously connected to the Internet 12.

The client 20 is typically a personal computer (“PC”) used by a buyer to order products from an affiliate 30 that is connected to the Internet 12. In addition, the client 20 includes a software application active on the PC known as a “browser.” A browser is an application program that provides a way to look at and interact with all the information on the World Wide Web. Technically, a Web browser is a client program that uses HTTP to make requests of Web servers throughout the Internet on behalf of the browser user. A browser provides a user interface for interfacing with another node of the Internet 12, and transmits information using standard connection and communications protocols such as HTTP.

When computer components are connected to the Internet and configured to transmit information, such information may be transmitted between nodes in a standard data format such as XML. The HTTP protocol and XML language are known to those skilled in the art, and are common means for Internet operation. When a node attempts to communicate information with another node, the information is transmitted across the Internet channels using HTTP and the information being communicated is often an information message encoded using XML. Thus, when a buyer uses a client browser 20 to access an vendor's affiliate 30 web site to order products from the vendor, the client sends a signal to the affiliate's URL and establishes a connection using HTTP.

While a vendor generally wants buyers to access their site in order to purchase products, the vendor may also want the affiliate 30 to verify that a client 20 has been authorized to access its web site before granting that client access to the affiliate's secure resources. Therefore, in addition to standard web-server hardware and software, the affiliate 30 includes an affiliate application 68. The affiliate application 68 includes software applications for implementing the ULA system 100, which authenticates a client 20 before granting access to the affiliate's secure web site resource. The affiliate application 68 comprises executable software, database tables and libraries for implementation of the ULA system 100, which are discussed later in greater detail.

To facilitate the ultimate goal of the ULA system 100 to authenticate a client 20 to one or more affiliates 30, the hub 10 acts as an intermediary in the ULA system. The hub 10 has an application, referred to as a hub application 56, which comprises various database tables, algorithms and libraries, in addition to special hardware for implementing Internet communications. The hardware of the hub 10 comprises standard Internet server computer components known to those skilled in the art for performing Internet communications. These components may comprise computing means, memory means, digital-data storage means, interface means for electrically connecting to the Internet, such as modems, and software for operating and controlling these various hardware components. In addition, the hub 10 may comprise firewall means for isolating their respective applications 56 and 68 from the Internet 12. Firewall technology is well known in the art. As with the affiliate and its components, the particular components of the hub will be discussed in detail later.

Turning now to a more detailed description of the affiliate 30, the affiliate includes two separate access addresses for communications with other nodes. A front-end address 35 is the address used for global access by any node that is part of the Internet 12. This front-end address 35 provides a connection 25 between a client 20 and a non-secure front page of an affiliate's 30 web site. Such a front page is commonly known as a “home” page.

The home page typically shows information about the affiliate's 30 business. For example, if the affiliate 30 is in the business of selling grocery products, the home page may convey information about the freshness of vegetables, the lowness of prices in general, or other competitive advantages of buying goods from the vendor. In addition, the home page may also provide a dialog box or other such control item, such as tabs, for accessing the affiliate's 30 services, which typically may be accessed only after access to the affiliate's secure resources have been established. If the client 20 is already logged into the affiliate 30, the affiliate component 50 grants access to the services requested by the client 20.

In addition, the affiliate 30 also comprises a secure backend address 33. This backend address 33 is used for communicating with the hub 10. This address 33 is used for communicating with the hub's 10 backend address 14. The backend address 33 of the affiliate 30 and the front-end address 35 of the affiliate 30 are both configured as passive sockets. The hub backend address 14 is configured as an active socket. The following provides a discussion of active and passive sockets, which are known in the art.

A passive socket continuously polls or “listens” for a request to perform some action. Thus, Internet computer server hardware typically has an passive socket for receiving action requests directing the server to perform whatever function it is configured to perform. For example, if a web site operator is in the business of providing news articles for viewing by a user 21 when a user access the news web site, a list of links appears such that when the user selects a link, the server sends information to the user for display by the user's computer browser. The request to send the requested link is received at the passive socket and immediately initiates the requested action upon reception of such request. In contrast, an active socket receives information and responds to action requests only if the attached computer equipment has activated the socket. However, an active socket does not allow access and control of the attached computer equipment and/or applications if the socket is in idle mode. Thus, unless a computer is expecting a request from another node, and has some way to identify and verify that requesting node is a safe node, the active socket remains idle as if it does not exist to other nodes.

The backend address 14 of the hub 10 provides an important security element of the present invention. The active socket 14 prevents surreptitious access by another node because an outside node cannot surreptitiously activate the hub 10 without the hub 10 having first established a connection with the node. Therefore, if a unauthorized node deceives the affiliate 30 into granting access to its secure resources, the active socket of the hub backend address 14 prevents the ULA system 100 from unwittingly providing unauthorized access to the hub. If unauthorized access of the hub 10 could be accomplished, the unauthorized user could then gain unauthorized access to other affiliates 30.

This feature of preventing unauthorized access is important because such covert access to an affiliate 30 would allow an unscrupulous computer hacker/user to appropriate another affiliate's sensitive information. While no computer system is completely immune to such unscrupulous attempts, if the ULA system 100 did not provide this security measure, a vendor who invested heavily in security measures would be subject to another affiliate's security, or lack thereof. Such other affiliate may not feel it necessary to invest in expensive security measures. Thus, if the hub did not use an active socket for communicating with affiliates, security of the ULA system would only be as strong as the weakest affiliate's security. However, since the ULA system hub 10 only uses an active socket 14 to communicate with affiliates 30, it is impossible for someone that gains unauthorized access to one affiliate's secure resources to thereby gain access to other affiliate's secure resources.

Although the hub 10 and the affiliate 30 both have secure backend addresses that cannot be used to login to the ULA system 100, they both also have front-end address as well that a client 20 may use to log in to the ULA system. A client 20 may attempt to login to the hub 10 first, or may attempt to access an affiliate 30 directly. If a client 20 attempts to access an affiliate 30 directly, the affiliate 30 determines whether the client 20 has an active session with the affiliate 30. This determination is made by querying whether the client 20 that is requesting access has established a token 160 on the client PC 20. If an established token 160 indicates that a current active session exists between the client 20 and the affiliate 30, the affiliate grants access to the client 20.

However, if an active cookie 160 is not present, the affiliate 30 directs the client 20 to the front-end address 13 of the hub 10 along connection path 15. Front-end address 13 is the same address the client 20 uses to gain access to any of the affiliates 30. Moreover, this front-end address 13 is the only address that can be used to cause the ULA system 100 to implement the authentication process to any of the plurality of affiliates 30.

In addition to redirecting a client 20 to the hub's 10 front-end address, the affiliate 30 sends login request token 120 to the hub. The token 120 that accompanies the redirected client 20 contains three primary pieces of information. These included the identity of the affiliate 30, the URL to which the client 20 should be redirected upon authenticated, and a variable that tells the hub 10 whether the affiliate requires an additional login. This affiliate-login token 120, and the information contained therein, will be discussed in greater detail later.

When a client 20 has been redirected to the hub's 10 front-end address 13, the hub application 56 performs operations and communications in concert with the affiliate application 68, to determine whether to grant the client access to the affiliate's 30 services. This determination is performed partly by the hub application 56 and partly by the affiliate application 68. The hub 10 communicates with the affiliate 30 along connection 27 between the hub's backend address 14 and the affiliate's backend address 33. The hub 10 also communicates certain parameters to the affiliate 30 when it redirects the client 20 from the hub to the affiliate front-end address 35. These parameters are used to authenticate the client 20, and are discussed in greater detail later.

To implement the connections and transfer of messages between each of the primary components of the ULA system 100 discussed above, each component uses secure means for communicating digital messages. More particularly, each client 20, each affiliate 30, and the hub 10 of the preferred embodiment use SSL. In addition, communications between the hub 10 and affiliate 30 may use certificate technology, such as X.509, to implement SSL protocol transmission. The keys used for digital certificate technology are administered by a certificate authority (“CA”). Digital certificate technology is well known in the art.

As mentioned above, the ULA system implements a zero trust arrangement between the three primary components of the system. The affiliate 30 may use token 160 to determine whether to grant a client access to its secure resources. This implementation is not required by the ULA system 100, but may be provided by the affiliate 30 to speed access time and to reduce the consumption of computing resources. However, if the affiliate 30 does not use cookie 160, the affiliate does not trust the client 20 and will always direct an access request to the hub 10 for authentication.

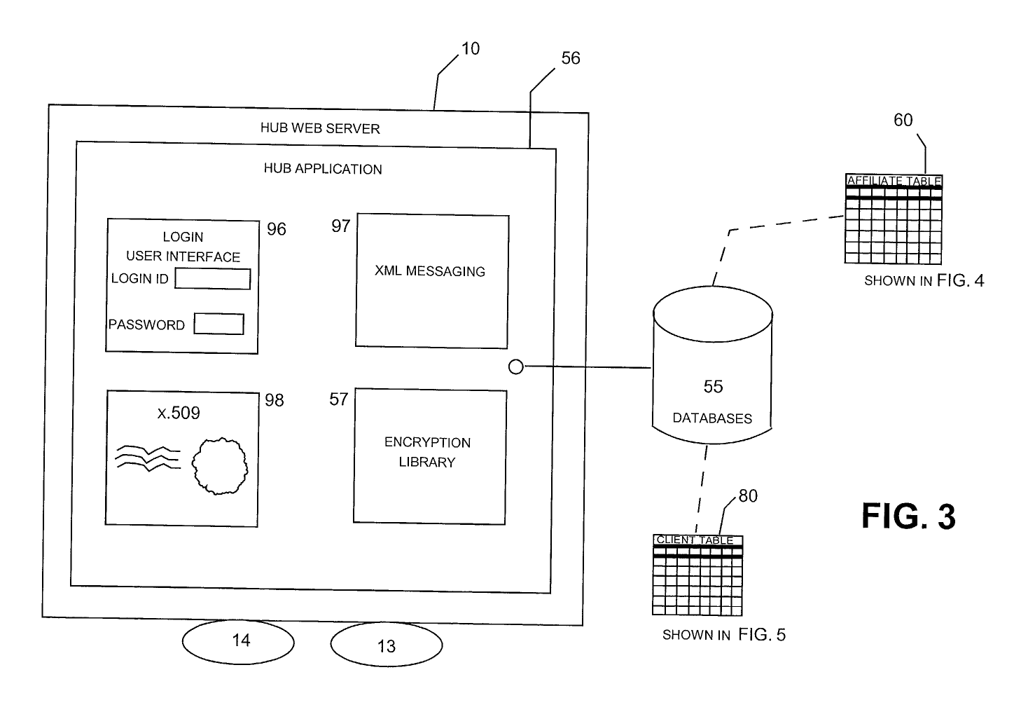

The hub also does not trust the client, and requires that the client submit login credentials before granting access to the client. As mentioned above, the hub does not permit an access request by an affiliate, or any other node, at the hub backend address 14. However, once a client successfully logs into the system, the hub establishes a secure cookie 130 so that future access requests can be quickly granted if the cookie 130 is active. The secure cookie 130 is digitally signed by the hub 10 and only accessible by the hub 10. This is accomplished by using the hub's 10 public key that is part of its certificate technology known in the art and performed by the hub certificate application 98, which is discussed further in connection with FIG. 3 below.

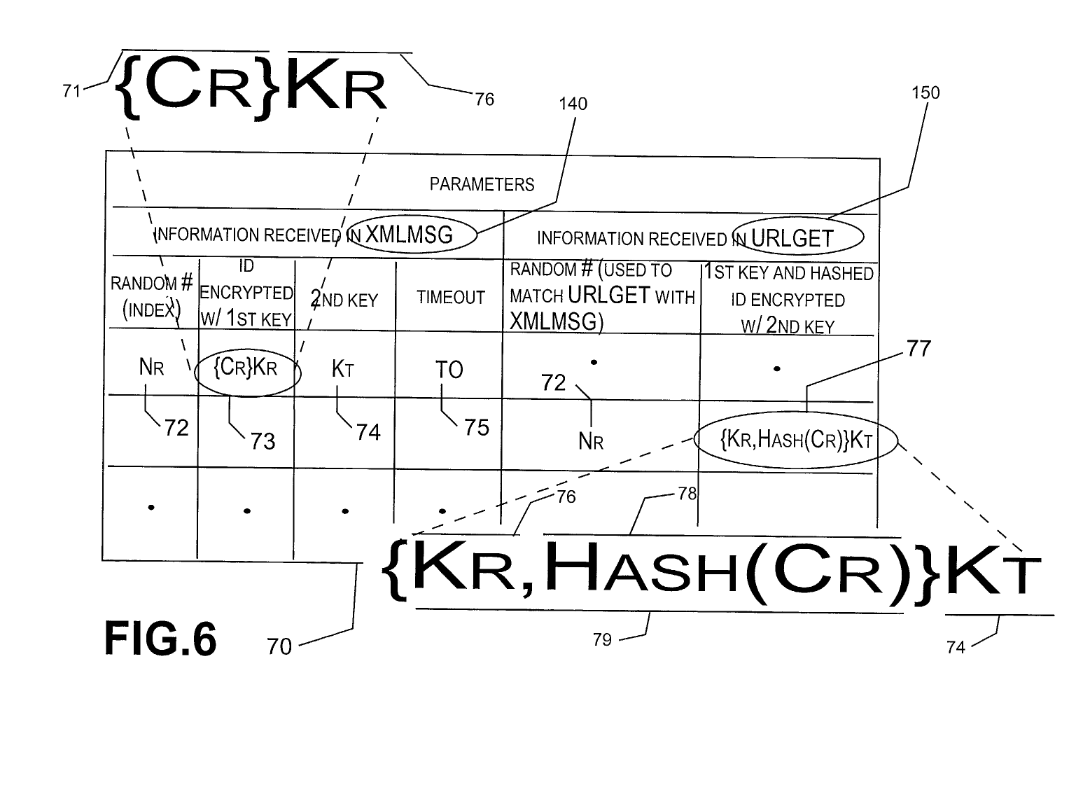

Finally, the affiliate does not trust the hub's 10 request to connect a client 20 without first processing certain information. Before an affiliate 30 grants access to a client 20, the affiliate must receive the UID 82 in two separate messages. The first message (“XMLMSG”) 140 is posted from the hub 10 to the affiliate along connection path 27. The second message (“URLGET”) 150 is sent from the hub 10 to the affiliate 30 as a GET parameter along with a redirect to the affiliate's 30 front-end address 35. XML posts and GET parameters are standard Internet process known in the art. The contents of each message are shown in the parameters database table 70, which is shown and described in detail later in connection with FIG. 6.

Each message is individually processed by the affiliate 30. The affiliate application 68 extracts the UID from the second message 150 and compares it to the UID extracted from the first message 140. The UID from the second message 150 must match the UID from the first message 140 before an affiliate 30 grants a client 20 access to its secure resources.

If the UIDs match, the affiliate 30 may create token 160 to establish the session between the client 20 and the affiliate 30, and redirect the client 20 to the secure resources. The redirect action is performed based on the backurl parameter 66 passed from the affiliate 30 in token 120. The backurl parameter 66 corresponds to the address of the affiliate's 30 secure resource that the client 20 originally sought. Thus, the affiliate 30 has utilized the ULA system 100 to authenticate the client 20 and grant the client access to the affiliate's secure resource that the client originally sought.

In addition to the physical and virtual components that comprise the ULA system 100, a method of processing information is also part of the present invention. Thus, a set of figures dedicated to illustrating the process steps of operating the ULA system 100 are shown and discussed later that depict the steps of implementing the process. Although a set of figures is dedicated to the steps of the process, FIG. 1 gives a broad overview of the major steps. These steps are represented in FIG. 1 as numbers 1-6, with each step enclosed in a circle; the flow of information depicted by dashed lines between the three primary components. It will be appreciated that the dashed lines associated with the six major steps have arrows indicating the flow direction of information. Moreover, the dashed lines associated with steps 3 and 6 have arrows at each end to indicate that tokens 130 and 160 are placed on the client PC 20, but are reviewed by the hub 10 and affiliate 30 to determine the status of the respective sessions.

Step 1 indicates that a client 20 attempts to access the secure resources of an affiliate 30. Any browser connected to the Internet 12 may be able to access the home page of an affiliate 30. However, a home page is typically not a secure resource. A secure resource is one that is implemented by the affiliate 30 using HTTPS, rather than HTTP, the standard, non-secure Internet protocol. When the client 20 attempts to access the affiliate's secure resource at step 1, the affiliate 30 determines whether the client is currently logged into the affiliate resource. This function is typically accomplished through the use of a token that is placed on the client PC 20. This token is shown by item 160 on FIG. 1. If a token 160 exists, the affiliate 30 grants access to the client 20.

However, if a current session has not been established through the use of a token, the client 20 is redirected to the hub 10 at step 2, to establish a connection at the hub's 10 front end address 13. When the redirection activity is performed, the affiliate also sends a message token 120 to the hub via the hub's front-end address 14. This token 120 contains the affiliate identification (aff_ID) 62, the return address (back_url) 66, and a login requirement variable (requirelogin) 65. The aff_ID 62 identifies the particular affiliate 30 that is sending the token 120. The hub 10 uses the aff_ID 62 to determine the proper cipher type 63 and hash routine 64 from the encryption library, which is shown as item 57 in FIG. 3 and discussed later in connection therewith.

When the client 20 has been redirected to the front-end address 13 of the hub 10 at step 2, the hub checks to see if a session token 130 has been established on the client at step 3. This token may be in the form of a cookie placed on the client PC 20, and is used by the hub 10 to determine if the client 20 has an active session with the hub 10. If an active session token 130 already exists, the process moves on to step 4. If the client 20 does not have an active session with the hub 10, the hub application 56 invokes interface application 96 to cause an interface to appear on client browser 20. The user 21 then enters login credentials into the interface. If the credentials are verified, then the token 130 is established at step 3 and the process proceeds to step 4.

At step 4, the first message 140 is generated and sent to the affiliate 33 via the backend address 33. Next, at step 5, the hub 10 generates the second message 150, and sends it as a parameter message to the affiliate 30 via the front-end address 35. This sending of the second message 150 and redirecting of the client 20 occur simultaneously, and are directed to the return URL address 66 that was part of token 120 sent to the hub 10 at step 2.

Then, the affiliate 30 decrypts the messages, compares the UID from each message and process the UID using a salting routine, as discussed later to retrieve the UID 82 from the first message. The affiliate 30 may then place token 160 on the client computer 20. This token 160 is used to establish the session between the client 20 and the affiliate 30 at step 6.

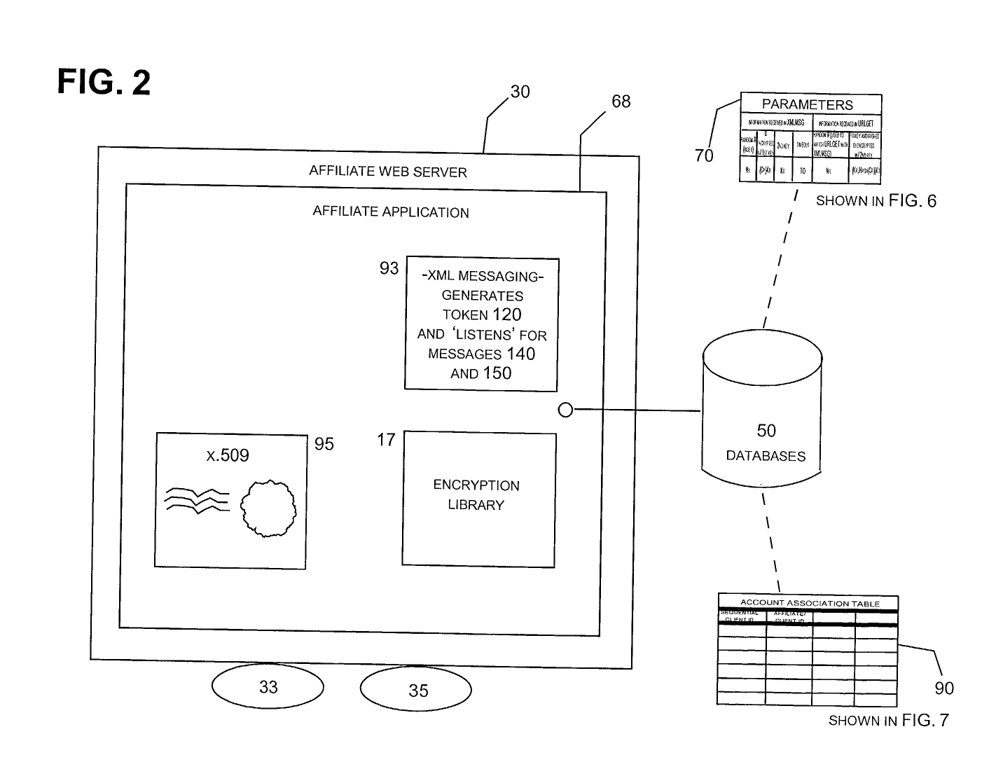

Turning now to FIG. 2, the figure illustrates the components of the affiliate application 68. The affiliate application 68 resides on the web server of the affiliate 30, wherein the server computer equipment comprises the hardware and software for facilitating Internet communications and actions. The web server components are Internet implementation components known in the art, which may include a computer server, as well as physical and software connections to the Internet. The active backend address 33 and the front-end address 35 are part of the standard web server equipment and software that composes the affiliate web server 30.

The affiliate application 68 comprises a variety of executable programs, e.g. programs for implementing the X.509 certificate verification operations 95 and means for sending and retrieving XML messages 93. The affiliate application also contains a library 17 of ciphers, salt routines, and hash routines. Although the particular ciphers and hash functions are known in the art, the library 17 serves the purpose of providing access to routines that match routines used by the hub 10 to implement the ULA system 100. The affiliate 30 must use the same routines used by the hub 10 to create the messages in order to extract the UID 82 sent from the hub 10 to the affiliate 30 in the messages. In addition, the affiliate application 68 that comprises a database section 50 that includes an account association table 90 and a parameters database table 70.

Similarly, FIG. 3 illustrates the hub application 56, which resides on the hub web server 10. The hub application 56 has means for generating a user interface 96, which is used for receiving the user's 21 login and password credentials. The hub application 56 also includes X.509 certificate implementation means 98, XML messaging means 97, and an encryption library 57. Like the affiliate application 68, the hub encryption library 57 also includes various cipher and hash function routines. However, the hub encryption library 57 is typically more comprehensive than the library 17 for a given affiliate 30 because the hub must contain cipher and hash routines for all the affiliates 30. Since each affiliate 30 may choose to use different cipher and hash functions than the other affiliates 30, the hub 10 must be able to support all the routines that any of the affiliates 30 may use.

The cipher algorithms are symmetric ciphers such as RC5, IDEA, 3DES and others. The message digest algorithms include algorithms for performing salt functions and hash functions, which may include MD5, SHA-1 and others. Also included are signature algorithms. All of these algorithms are known in the art, and may change as new algorithms are developed in the art. The sophistication (higher sophistication requires more processing resources) of the actual cipher used is important to the extent of the ability of hostile computers to attack an affiliate 30 or hub 10 and perform the particular algorithm being used. As long as the hub 10 knows which cipher, hash function and other algorithms the affiliate 30 uses, the hub 10 can encrypt messages that the affiliate 30 can decrypt. Thus, the hub 10 maintains in its library 57 the various cipher and hash algorithms that any one of the affiliates 30 may use.

The hub application 56 associates the cipher and hash algorithms with the appropriate affiliate 30. This association is achieved through the use the affiliate table 60, which is part of database component 55. Database component 55 includes client table 80. Client table 80 is used to match credentials entered by a user 21 with the user's sequential UID 82, which was created when the user registered with the hub 10. These tables, as well as the tables included in the affiliate database component 50 will be discussed in detail next.

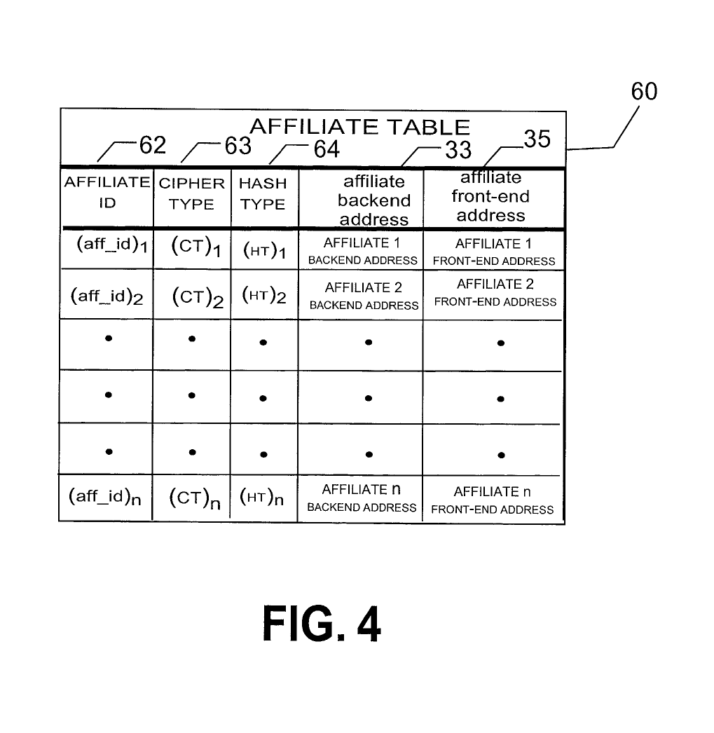

Turning now to FIG. 4, the affiliate table 60 shown in FIG. 4 is maintained on the hub 10 and is accessed by the hub application 56. The affiliate table 60 is indexed according to the plurality of affiliates 30, which are represented in table 60 by according to Aff_ID 62. The affiliate table 60 is used to associate the cipher type 63, the hash type 64, the backend address 33 of the affiliate 30 , and the front-end address 35 for each affiliate 30. Thus, when the hub 10 receives an initial login request token 120 from the affiliate 30, the hub 10 knows which algorithms to use, because the algorithm types are already stored in the database table 60.

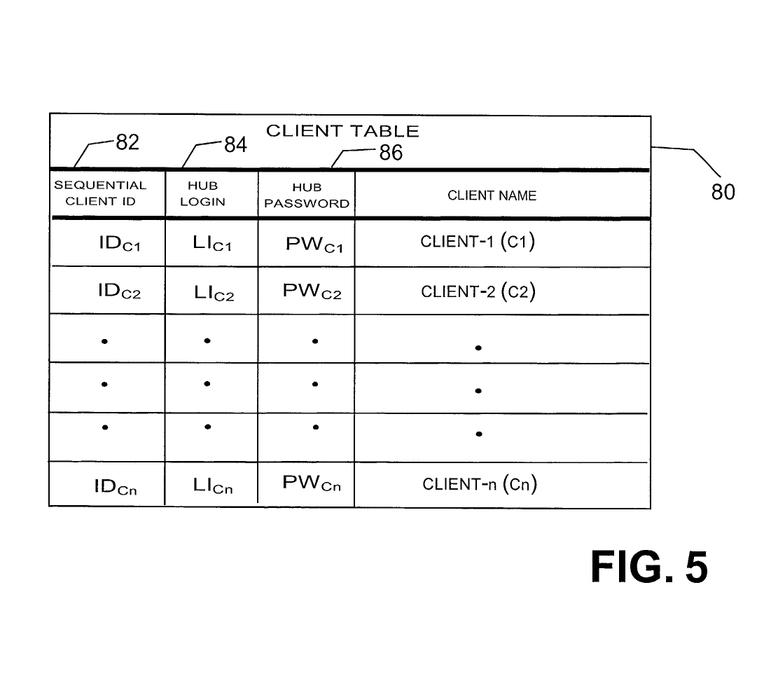

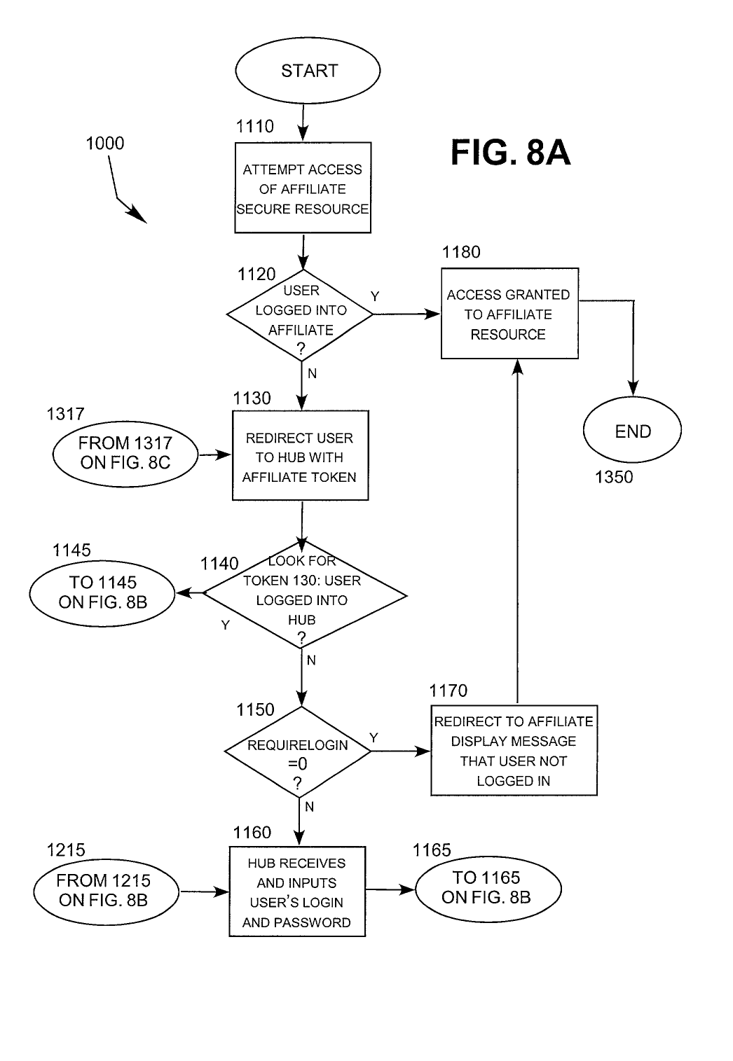

Turning now to FIG. 5, the figure illustrates the client table 80 maintained on the hub 10 and accessible by the hub application 56. This table is used by the hub 10 to associate a client's login credentials with UID 82. The login credentials comprise a hub login character string 84 and a hub password character string 86. These character strings are selected by a user 21 upon registering with the hub 10. When each user 21 registers, the hub generates a sequential identification 82. This UID 82 is associated with the login credentials. Thus, when a user 21 makes a login request by entering the login 84 and password 86 into the interface 96, the hub searches the client table 80, which is indexed on the login 84, and determines whether the password 86 received from the client 20 matches the associated password 86 in the table. If so, the hub application 56 retrieves the associated sequential UID 82 and generates the first message 140 and second message 150. The process of generating the first message 140 and the second message 150 will be discussed in detail later in connection with discussion of FIG. 8B.

Turning now to FIG. 6, the figure illustrates the information that is contained in the two messages sent from the hub to the affiliate. The first message 140 is sent to the affiliate 30 after a login request is received by the hub. This first message 140 contains a random number N_{R} 72 and a salted version of the client UID 82. The salted version of UID 82 is referred to as C_{R} 71. The salted UID 71 is encrypted with a first key K_{R} 76 to result in encrypted version of the salted UID. The encrypted version is referred to as {C_{R}}K_{R} 73. In addition, the first message also includes a second key K_{T} 74 and a timeout instruction TO 75.

The random number 72 may be generated in any of a number of ways, which are known to those skilled in the art. The random number 72 is used to match the second message 150 to the first message 140, as will be discussed later in connection with FIG. 8C. The first key 76 and the second key 74 are randomly generated as well. The methods used to create the random keys may be similar to the method used to generate the random number, or may be different. Thus, the method(s) used to generate the random number and keys is/are not critical since the affiliate application 68 uses, as is, whatever numbers and keys are passed from the hub 10. The affiliate application 68 does not care how the random number 72 and keys were generated as long as they are received in a predetermined format.

As discussed above, the salted UID 71 is a salted version of the sequential UID 82. To salt the UID 82, the UID is concatenated with the session token 130 and a random salt number generated by the hub. A bitwise exclusive OR (“XOR”) operation is performed on the resulting string. This XOR operation results in the salted UID 71 that is used to generate the first message 140 and the second message 150. Such XOR methods are known in the art.

The timeout instruction 75 is a time marker established when the user credentials have been verified by the hub 10 and the messages are prepared for transmission to the affiliate 30. The timeout instruction 75 imposes a certain period, approximately 3-5 minutes, in which the affiliate 30 must authenticate a client 20. This period is determined such that the time to successively attack a given cipher or hash function is greater that the timeout instruction 75. Thus, if the second message 150 is not processed with a positive comparison to the first message before the timeout function expires, the client 20 will not be authenticated and will not be permitted to access the secure resource of the affiliate 30.

Turning now to the second message 150, the second message is sent from the hub 10 to the affiliate 30 after the first message 140 has been sent. The second message 150 comprises a random number 72. This is the same random number 72 previously generated and included in the first message 140. Thus, after the first message 140 has been received, stored and indexed according to the random number 72 by the affiliate 30, the random number 72 of the second message 150 is used to match the second message 150 to the first message 140. The second message 150 also comprises an intermediate data packet 79, which includes the first key 76 that was generated randomly when the first message 140 was generated. In addition, the hub application 56 hashes the salted sequential UID 71, according to a predetermined hash function, to create a hashed-salted-UID 78, which is also part of the intermediate data packet 79. Finally, the intermediate data packet 79 is encrypted with the same second random key 74 that was sent as part of the first message 140. Thus, the information in the second message 150 is also contained in the first message 140, but in a different form.

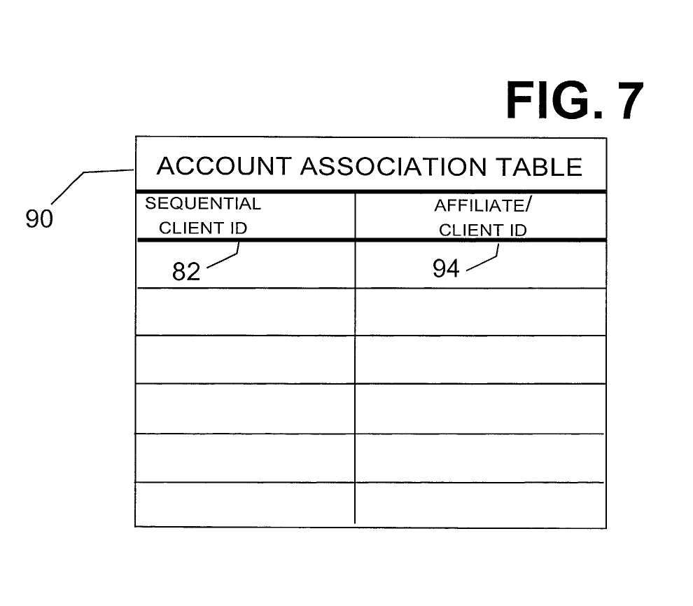

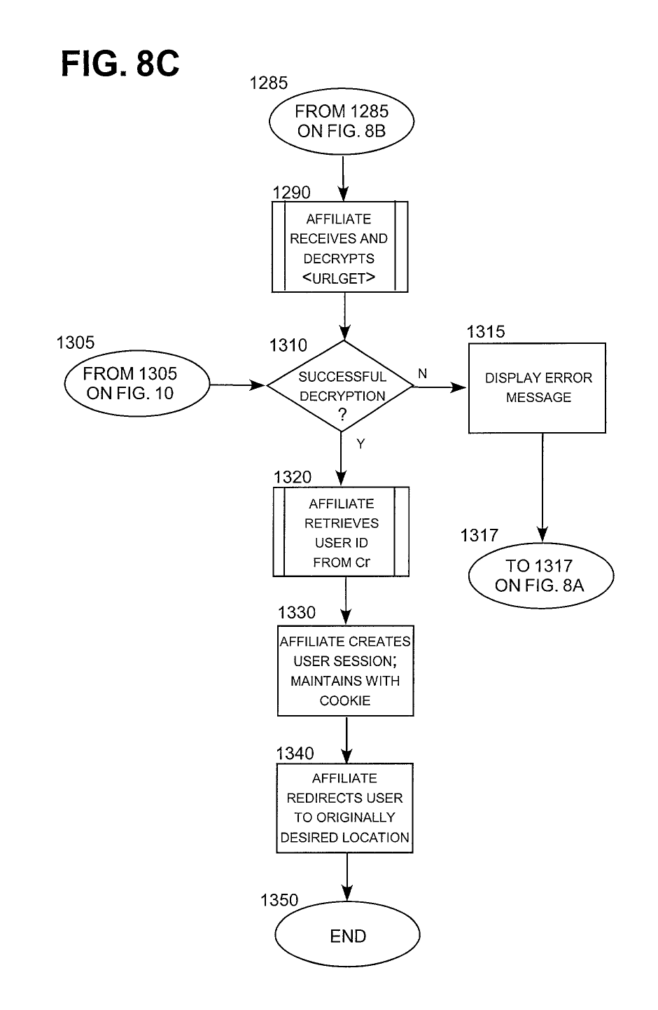

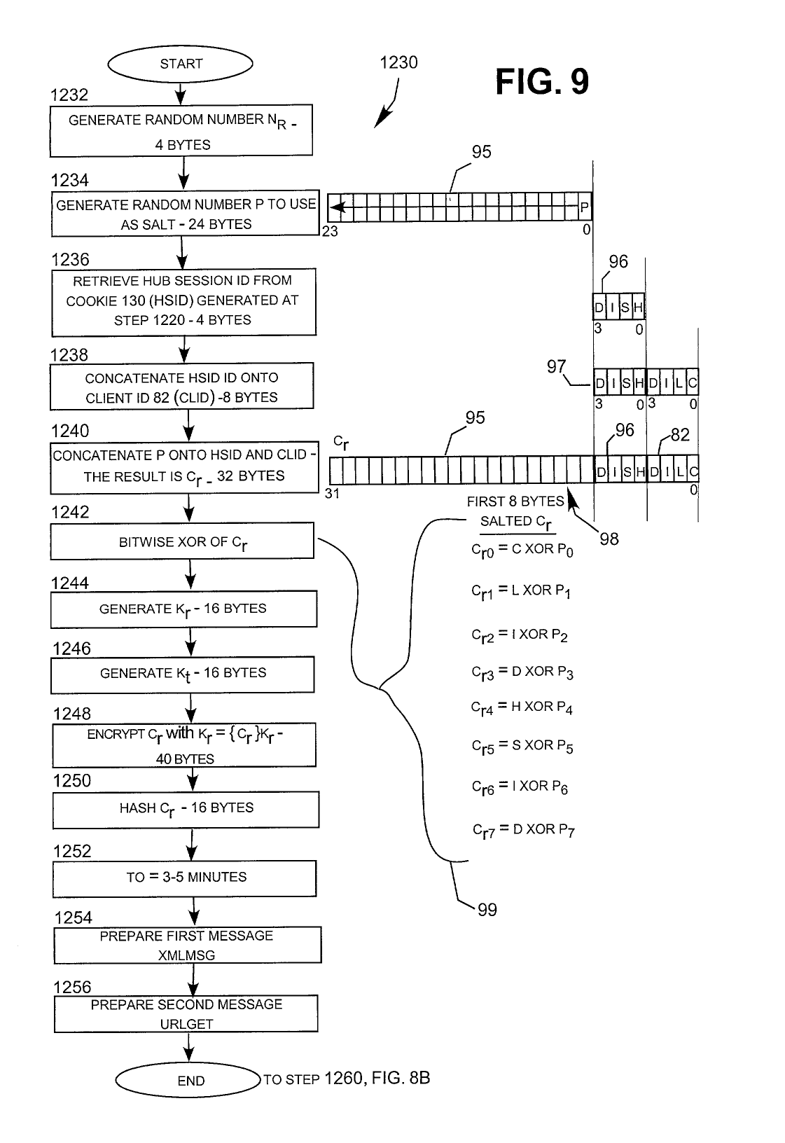

Turning now to FIG. 7, the figure illustrates an account association table 90 used by the affiliate 30. When both the first message and the second message have been retrieved and processed by the affiliate application 68, and the UID 82 has been unsalted (the algorithm for processing and unsalting the information in the messages will be discussed later in connection with FIGS. 10 and 11), the affiliate application 68 uses the UID 82 to retrieve the associated account number for the particular client 20. This account number is the client ID 94, which is generated by the affiliate application 68 to conforms to the internal accounting system of the vendor that operates the affiliate 30. The affiliate's client ID 94 is used by the vendor for its own internal purposes, such as accounting, report generation, invoicing, etc. The association between the UID 82 and the affiliate's client ID 94 is maintained in the account associate table 90.

Thus, when the two messages have been processed, and the client 20 has been successfully redirected and logged in to the affiliate's 30 secure resources, any information exchange and interaction between the client 20 and the affiliate 30 will be associated with the vendor's internal account number client ID 94. For example, if a user 21 is a restaurant and the vendor is a bank, any transaction, such as verifying a checking account balance, will appear on the client browser 20 as affecting the user's personal checking account number.

Turning now to FIG. 8A and related figures FIG. 8B and FIG. 8C, the overall method 1000 for implementing the ULA system 100 is illustrated. The process begins when a user 21 attempts to access a secure resource of an affiliate 30 at step 1110. The affiliate application 68 determines whether the client 20 is logged into the computer server of as affiliate 30 at step 1120. This determination at step 1120 is made by querying the client browser 20 to see if an active session token 160 is present. If an active session token is present at step 1120, the affiliate grants access to the secure resource at step 1180 and the process ends at step 1350.

However, if an active session token 160 at step 1120 does not exists, the affiliate 30 redirects the client 20 to the hub front-end address 13 at step 1130. Token 120 is sent to the hub 10 from the affiliate 30 at step 1135. At step 1140, the hub 10 determines whether the client 20 is logged into the system by querying the client 20 to determine whether an active session token 130 is present on the client PC 20. If the query indicates that an active session token 130 is present, the ULA system 100 system follows path “Y” at step 1140, which leads to step 1230, as shown on FIG. 8B and discussed later.

However, if the client 20 is not logged into the hub 10, and therefore no active token 130 is present, the next step is to determine at step 1150 the value of the requirelogin variable 65. The requirelogin variable 65 is part of token 120, which was passed from the affiliate 30 to the hub 10 at step 2 shown in FIG. 1 and is used to indicate whether an affiliate requires implementation of the ULA system 100 before granting access to its secure resources. An affiliate may not require login if the resources sought by the user 21 do not require authentication. For example, if a vendor sells office products, no sensitive information, such as account number or balance, is at stake. The user 21 would simply select items to purchase and then enter a shipping address and a credit card account number. However, if the buyer wishes to use profile information already stored, instead of entering shipping address, credit card account number, etc., a secure resource would likely be accessed, in which case the requirelogin variable 65 would not be zero.

If requirelogin variable 65 equals zero, the affiliate 30 that sent token 120 containing requirelogin does not require login. Thus, if the value of variable 65 is determined to be zero at step 1150, the hub redirects the client 20 to the affiliate 30 at step 1170. The address to which the client 20 is redirected is the backurl address 66, which was passed from the affiliate 30 to the hub 10 at step 2 shown in FIG. 1. Then the client 20 is granted access to the affiliate 30 client 20 at step 1180, and the process ends at step 1190.

If the value of variable 65 is not determined to be equal to zero at step 1150, the hub interface application 96 displays a user interface at the client 20 for receiving login and password credentials at step 1160. Then the process proceeds to step 1165 and on to step 1210 shown on FIG. 8B.

At step 1210 the hub 10 determines whether the credentials received from the user interface application 96 are valid. The determination is made by comparing the credentials received at step 1160 to the credentials from the client table 80 shown in FIG. 5. Since the client table 80 is indexed according to login 84, the hub application 56 searches to determine if an entry in the column for hub login 84 contains an entry equal to the login received at step 1160. If no matching entry exists, the process continues to step 1215, which returns control to the hub at step 1160, so that the user 21 may attempt to enter a correct login.

If the hub 10 determines at step 1210 that the login received at step 1160 has a matching entry in the client table 80, it then checks to determine whether the password received at step 1160 matches the associated password from table 80. If the passwords do not match, control is passed back to step 1215, and thus back to step 1160 on FIG. 8A, to allow the user 21 to enter the correct password. If both credentials are equal to the corresponding credentials in the client table 80, the hub application 56 retrieves the associated UID 82 from the client table 80 for later use, and establishes a session token 130 on the client 20 at step 1220. Thus, the client 20 is logged into the hub 10.

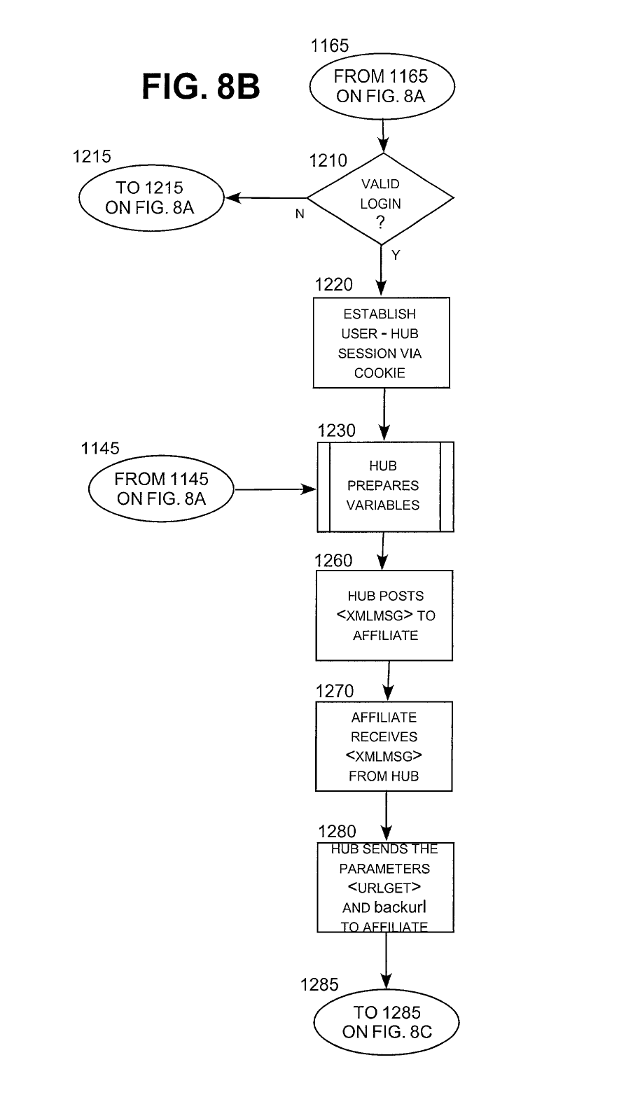

After the client 20 has been logged into the hub 10, the next step is to prepare variables that are used in the messages sent to the affiliate 30 for authentication purposes. These variables are prepared at step 1230, the details of which will be discussed later in connection with FIG. 9.

If an affiliate 30 requires authentication, the ULA system 100 requires step 1230 regardless of whether the client 20 is already logged in to the hub 10 as determined at step 1140. This is because to reach step 1230, the affiliate 30 would have had to determine at step 1120 that a token 160 was not present, and thus, that the client 20 was not logged into the affiliate 30. Otherwise, access to the affiliate 30 would have been granted at step 1180, immediately after step 1120. However, if evaluation of requirelogin 65 equals zero at step 1150, the affiliate 30 does not require logging in. Thus, step 1230 would not be reached because step 1150 would redirect the client 20 to the affiliate 30 at step 1170. This scenario arises when a client 20 logged into the hub 10 accesses an affiliated vendor's web site that does not require ULA authorization from the hub 10. Such an affiliate may not wish to secure its resources using the ULA system 100, but may nevertheless maintain an active link to its web site on the user interface of the hub 10. The purpose of such an arrangement may be that the non-secure affiliate 30 hopes to attract users of other ULA system 100 affiliates to its web site, or other various marketing reasons.

After the variables have been prepared at step 1230, the hub application 56 generates the first message 140 with the XML message generator 97. The first message 140 is posted to the affiliate 30 via the backend address path 27 at step 1260. The hub application 56 posts the first message 140 to the affiliate 30 using the X.509 certificate application 98. Thus, when the affiliate 30 receives the first message 140, the affiliate 30 is assured that the first message 140 is from the hub 10, and not an imposter.

The hub 10 encrypts the first message 140 using the affiliate's 30 public key. The affiliate 30 decrypts the message 140 with using its private key. The keys are administered by a certificate authority (“CA”). Messages sent from the affiliate 30 to the hub 10 via the backend address path 27 are also sent using X.509 certificate technology, but such messages are encrypted with the hub's public key and decrypted by the hub 10 using its private key. Such public/private key certificate technology using a CA is known in the art and requires no further explanation.

The affiliate 30 receives the first message 140 at step 1270 and stores the message temporarily. Next, the hub application 56 generates the second message 150 with the XML message generator 97. The second message 150 is sent along with the return address 66 received as part of token 120 at step 1135 as an HTTP redirect of the client browser 20 to the address found in the backurl variable 66 passed from the affiliate 30 to the hub 10 at step 2 shown in FIG. 1. The redirect of client 20 establishes path 25 shown in FIG. 1, such that the client is attached to the front end address 35 of the affiliate 30 at step 1280. The process then continues to step 1285, which leads directly to step 1285 on FIG. 8C.

Turning to FIG. 8C, the process receives control from step 1285 and proceeds to step 1290. At step 1290, the affiliate 30 receives the second message 150 and decrypts it. This process is shown in detail in connection with the discussion of FIG. 10.

At step 1310, the process determines whether the decryption at step 1290 was successful. The process for determining whether the decryption was successful is described in connection with FIG. 10. If the decryption was not successful, the process follows the “N” path and causes the browser of the client 20 to display an error message at step 1315. When the error message is displayed, the process moves on to step 1317, which passes control back to step 1130 shown on FIG. 8A. Thus, the ULA system 100 system allows a user 21 to enter login credentials again. This error process would occur if the timeout instruction 75 had terminated the session, or if the information in the first message 140 did not correspond with the information in the second message 150. The timeout instruction 75 may expire for a number of reasons, including Internet congestion causing delays between the preparation of variables and the sending of the two messages. In addition, processing delays at the affiliate 30, or a hostile attack on the system from a node that has intercepted the first message may also cause the timeout function to expire. The period of the timeout instruction 75 is conservatively set by the hub to be less that the time, determined from empirical testing, required to successfully attack the cipher or hash function. Therefore, the goal of the timeout instruction 75 is to terminate the authentication process before any unscrupulous attacker can successfully attack the ULA system 100.

If the decryption at step 1310 was successful, the process follows the “Y” path, and the affiliate then retrieves the UID 82 from the salted UID C_{R} 71 of message 140 at step 1320. This retrieved UID 82 is then used to search the account association table 90, shown in FIG. 7, which is indexed according to UID 82. The affiliate application 68 uses UID 82 to retrieve the associated client UID 94 to be used by the affiliate 30 for internal record keeping purposes as described earlier. When the ID 94 has been retrieved, the affiliate 30 establishes a session between the affiliate 30 and the client 20, by placing token 160 on the client 20. This token 160, which is only used by the affiliate 30, is used to determine at step 1120 whether the client has an active session with the affiliate 30. Thus, if such determination at step 1120 is affirmative, the process can bypass the steps following step 1120, thereby proceeding directly to step 1180.

When the session token has been established at step 1330, the process proceeds to step 1340, at which point the affiliate 30 redirects the client 20 to the URL originally requested at step 1100. The affiliate 30 obtains this redirect URL from the parameters that were sent along with message 140 at step 1260 from the hub. In fact, this is the same URL that was sent as backurl 66 in token 120 from the affiliate to the hub at step 1135. When this redirect step 1340 is complete, the ULA process ends at step 1350.

Turning now to FIG. 9, the routine of preparing the variables in FIG. 8B is shown in more detail. The hub application 56 generates a random number 72 at step 1232. This number may be generated in any manner desired by the hub application 56. Such methods of generating random numbers are known in the art. The random number is four bytes long, and is stored in least-significant-byte-first format. In the art, this format is sometimes referred to as “little-endian.” Thus, when viewing the order of the bytes of the random number 72, the address number of each byte decreases as the data is read from left to right. The little-endian format is the format that most personal computers presently use. Thus, all the digital information discussed in this description will be described and shown in the figures in the little-endian format.

After the random number 72 has been generated, the hub application 56 generates another random number to be used as a salt value P 95 at step 1234. A salt is a string of random (or pseudo-random) bits concatenated with a key or password to foil pre-computation attacks. In the present invention, the salt value P 95 is a twenty-four byte little-endian number. FIG. 9 shows a graphical depiction of the salt value P 95 adjacent to step 1234. The salt 95 is shown with byte 0 at the right and byte 23 at the left.

At step 1236, the hub application 56 retrieves the hub session ID (“HSID”) 96 from the token 130. The token 130 comprises the HSID 96 in encrypted form using standard encryption methods known in the art. The HSID 96 is a four-byte number in little-endian form. Thus, FIG. 9 shows the HSID 96 in reverse when read from left to right.

Next, at step 1238, the hub retrieves the UID 82 (“CLID”) from the client table 80, and concatenates the CLID 82 with the HSID 96. The UID 82 is referred to as “CLID” in connection with FIG. 9 to facilitate graphical representation of a four byte string. Similarly, the token 130 is referred to as “HSID” so that it can be graphically shown in FIG. 9 as a four byte string. Both are shown in little-endian format. The result of this step 1238 is concatenated ID 97, which is an eight byte, little-endian number.

At step 1240, the hub application 56 concatenates the salt 95 onto the concatenated ID 97. Each of the three parts of this string are shown in the graphic adjacent to step 1240 on FIG. 5. This composite string is the variable Cᵣ 98. Thus, Cᵣ 98 is a string that is thirty-two bytes long in little-endian format.

At step, 1242, the salt value P 95 is applied to the concatenated ID 97. This salting process entails a bitwise XOR operation, as discussed above in connection with FIG. 8C. This operation of this function is represented by Eq. 1 below:

For(int i=0; i<8; I++){Cᵣ[i]=Cᵣ[i] XOR Cᵣ[i+8]}. Eq. 1

The result of applying the algorithm represented by Eq. 1 is the salted Cᵣ variable 99. This salted version is also of byte-length 32 in little-endian format. FIG. 9 shows how the first eight bytes of Cᵣ 99 are determined. The first byte of Cᵣ 99 is achieved by performing an XOR of byte zero of Cᵣ 98, which is byte zero of the CLID 97, with byte eight of Cᵣ 98, which is byte zero of salt 95. This process of Eq. 1 is repeated seven more times, but the operands of the XOR function differ as the XOR instruction pointer shifts one byte to the left with each iteration. Thus, the second iteration performs an XOR between byte one of the Cᵣ 98, which is byte one of the CLID 97, and byte nine of the Cᵣ 98, which is byte one of the salt 95. Likewise, byte four of Cᵣ 98, which is byte zero of the HSID 96, and byte thirteen of the Cr 98, which is byte five of the salt 95, are the operands of the fifth iteration. When all eight iterations have been performed, the bytes Cᵣ0-Cᵣ7 become the first eight bytes of the salted Cᵣ 99, and the salt value 95 remains as the last twenty-four bytes of the salted Cᵣ 99.

After the UID has been salted, the routine 1230 generates two sixteen byte random keys Kᵣ 76 and Kₜ 74 at steps 1244 and 1246 respectively. Both keys are generated using whatever method the hub application 56 prefers.

At step 1248, the hub 10 encrypts salted Cᵣ 99 to result in forty byte {Cᵣ}Kᵣ 73, which is in little endian-format. After Cᵣ 99 has been encrypted at step 1248, at step 1250, Cᵣ 99 is hashed with a hash function to generate sixteen byte hash(Cᵣ) 78, which is in little-endian format. The cipher encryption routine used for step 1248 may be any of the encryption routines from the encryption library 57, but must be a cipher type 63 that corresponds to the aff_ID 62 in affiliate table 60. Cipher type 63 is the type associated with aff_ID 62 that was passed from affiliate 30 to hub 10 in token 120 as shown in FIG. 1. Similarly, at step 1250, the hub application 56 uses the hash type 64 from affiliate table 60 that corresponds to the aff_ID 62 passed from affiliate 30 to the hub 10 in token 120 as shown on FIG. 1.

At step 1252, the timeout instruction TO 75 is generated. Timeout instruction TO 75 is a predetermined suggested number in XML format, which may be used by the affiliate application 68 to set a timer. After the timer counts down from the predetermined number to zero, the affiliate application 68 will not perform a decryption of {Cᵣ}Kᵣ 73, as discussed later in connection with FIG. 10.

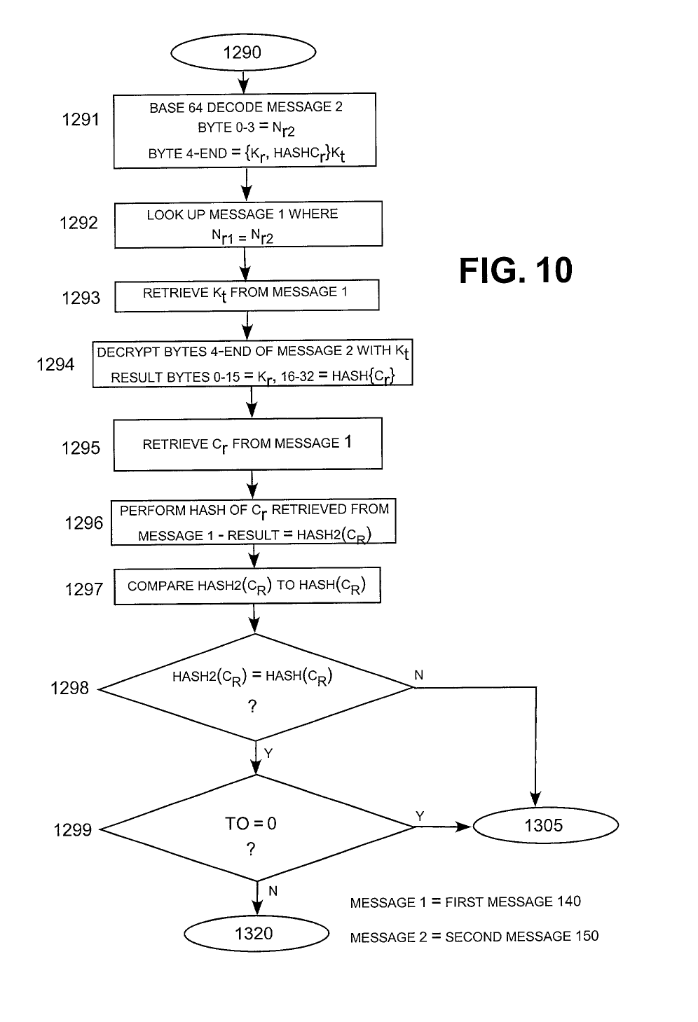

After the variables described above have been generated, the hub application 56 prepares the first message XMLMSG 140 at step 1254. The hub application 56 prepares the first message 140 in an XML message format 145 as shown in FIG. 12.

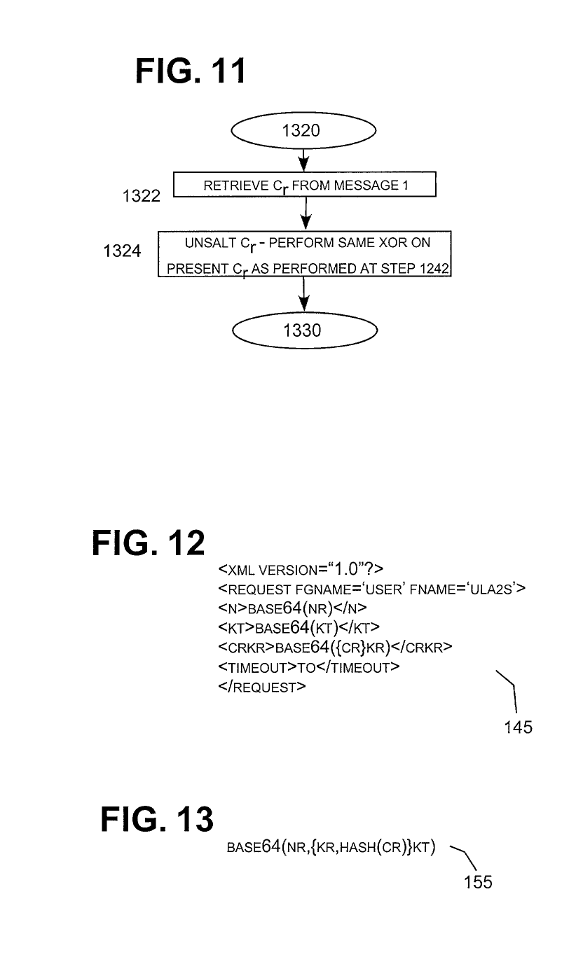

Returning to FIG. 9, after the hub application 56 prepares the first message 140, the hub application 56 prepares the second message URLGET 150 at step 1256. The second message URLGET 150 is as a URL parameter format 155 as shown in FIG. 13. After the variables have been prepared, the process returns to step 1260 shown in FIG. 8B.

Turning now to FIG. 10, the process of decrypting the second message 150 and determining whether the decryption is valid is shown. At step 1291, the affiliate application 68 performs a base64 decode of the second message 150. Base64 is a data format known in the art. Bytes 0-3 contain the random number 72, which is designated as Nᵣ₂ in the figure, to indicate that it is the random number 72 from the second message 150, as distinguished from random number 72 in the first message. At step 1292, the affiliate application retrieves the first message 140 from the parameters database table 70, which contains all first messages 140 received from various client-hub sessions and indexed on random number 72. Next, at step 1293, the affiliate application 68 retrieves the second random key Kₜ 74 from the first message.

After the second random key Kₜ 74 has been retrieved from the first message, the affiliate application 68 decrypts the encrypted intermediate data packet 77 using the second random key Kₜ 74 at step 1294. The cipher type used to decrypt packet 77 is loaded by the affiliate application 68 from the library 17, and corresponds to the cipher type sent to the hub in token 120. Encrypted data packet 77 is byte 4 through the end of the second message 150. The result after decryption is intermediate data packet 79. Bytes 0-15 of data packet 79 contain the first random key Kᵣ 76, and bytes 16-32 are the hashed-salted Cᵣ 78. However, the hashed-salted Cᵣ 78 may be bytes 16-37, depending upon the hash routine used at step 1250.

After the second message 150 has been decrypted, the affiliate application 68 retrieves the salted Cᵣ 99 (shown as item 71 in FIG. 6) from the first message at step 1295. Then, at step 1296, the affiliate application 68 performs a hash of salted Cᵣ 99 using a hash routine from library 17 that is the same routine used by the hub application 56 to hash the salted Cᵣ 99 at step 1250; such hash routine of course matches the hash type 64 that is associated with the AFF_UID variable 62 sent to the hub 10 in token 120. The result of this second hash at step 1296 results in hash2(Cᵣ). At step 1297, hash2(Cᵣ) is compared to hash(Cᵣ) 78 decrypted from the second message 150 at step 1294.

If a negative comparison results at step 1298, the process follows the “N” path to step 1305, which returns control to step 1310 on FIG. 8C, and on to step 1315 as discussed above. If a positive comparison results at step 1298, the “Y” path is followed on FIG. 10, and a determination of the timeout instruction 75 is made at step 1299. If whatever timer function being used at the affiliate application 68 has counted timeout instruction TO to zero, then the process follows “N” path at step 1299 to step 1320, as shown on FIG. 8C and FIG. 7.

Turning to FIG. 11, the process of recovering the UID 82 from salted Cᵣ 99 is shown. At step 1322, the affiliate application 68 retrieves the salted Cᵣ 99 from the first message 140. The salted Cᵣ 99 is unsalted at step 1324. This process applies the same XOR function for eight iterations on salted Cᵣ 99 that was performed at step 1242 on FIG. 9. The XOR operation of step 1324 yields the original thirty-two byte Cᵣ 98. CLID 82 is recovered from the first four bytes of the result from the XOR function at step 1324. After all four bytes of CLID 82 been recovered in little-endian order, the routine returns control to step 1330 shown on FIG. 8C.

This concludes the description of the various components and method routines of the ULA system 100. Next, a description of some of the user interface screens seen by a user 21 will be described.

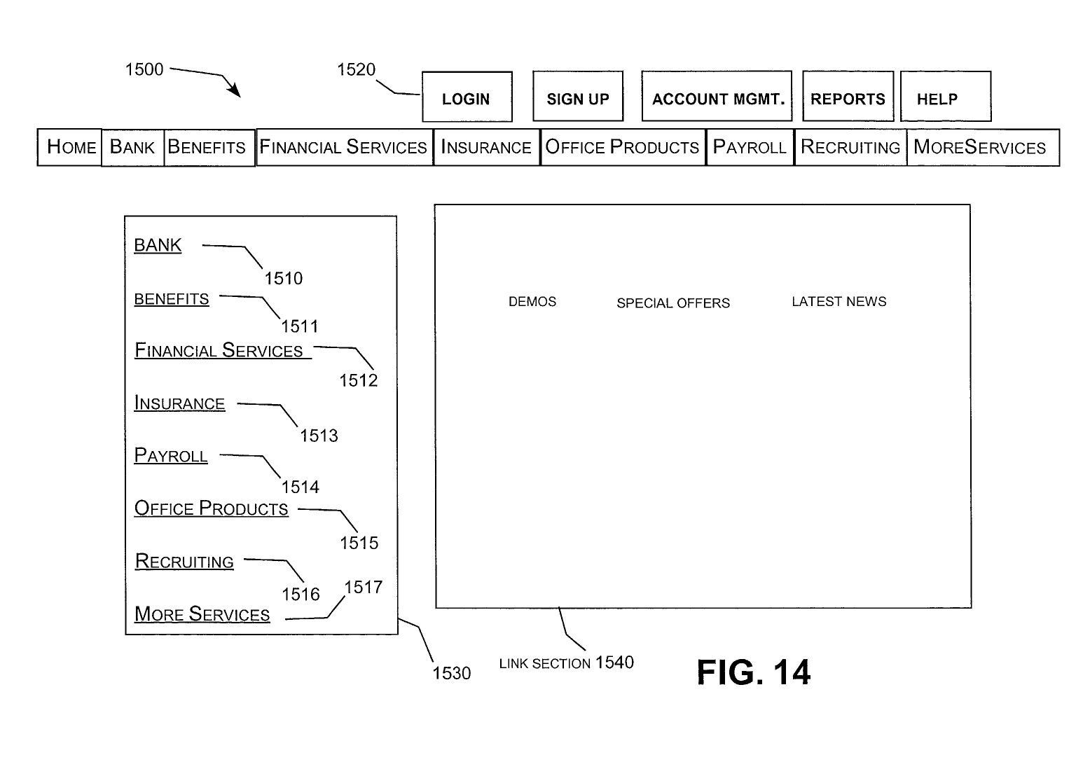

Turning now to FIG. 14, the figure depicts a typical hub home page 1500. The home page 1500 is a web page that does not require any login credentials to access. Thus, it is accessible by anyone using the Internet. Home page 1500 provides a link section 1540 that displays information about the hub operator and links for certain services provided by the operator. The home page 1500 also provides an affiliate section 1530. The affiliate section 1530 contains control items that provide active links to various affiliates 30. For example, the bank control item 1510 directs a client 20 to an affiliate 30 that is a bank upon activation by a user 21 at the client 20. Likewise, the benefits control item 1511 leads to an affiliate 30 operated by a service provider in the business of employee benefits. The other control items 1512-1517 also lead to various affiliates 30 whose business corresponds to the designation displayed on the control item. In addition to service providers, control item 1515 provides a link to an affiliate operated by a vendor that sells office products & supplies. Thus, these control items in the affiliate section 1530 link to affiliates 30 as shown in FIG. 8A at step 1110 when a user 21 attempts to access an affiliate secure resource.

However, the login control item 1520 is selected by a user 21 to directly login to the hub 10. Doing so does not immediately direct a client 20 to an affiliate secure resource, but establishes token 130, that is used, as discussed above in connection with FIG. 8A, to facilitate access to an affiliate's 30 secure resource. Thus, when a user 21 logs in to the hub 10 at step 1160 on FIG. 8A, either by using control item 1520, or attempting to access an affiliate via control items from affiliate section 1530, the hub application 56 creates token 130 and places it on the client 20.

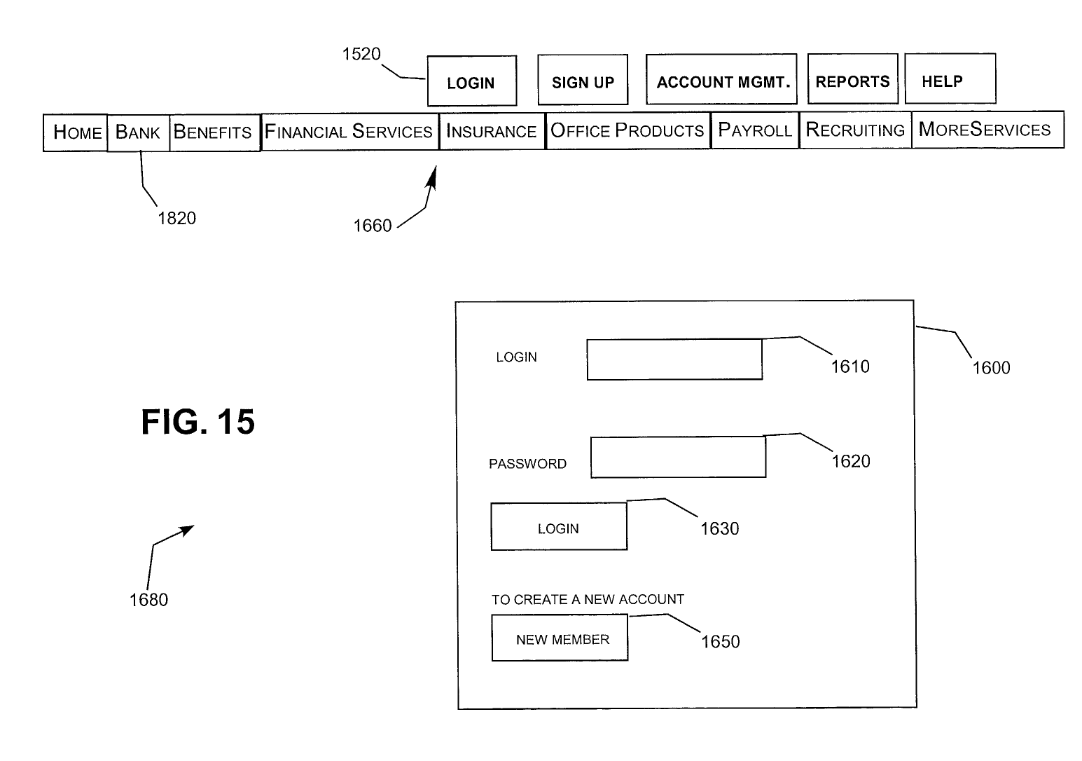

Turning now to FIG. 15, the figure illustrates the login credentials interface 1680. Login section 1600 contains the dialog box means for entering login 1610 and password 1620 credentials. When the credentials have been entered into the dialog boxes, the user 21 submits the credentials by selecting the control item 1630. These credentials are then used by the hub application 56 to determine if the user is a valid user. This step corresponds to step 1160 on FIG. 8A.

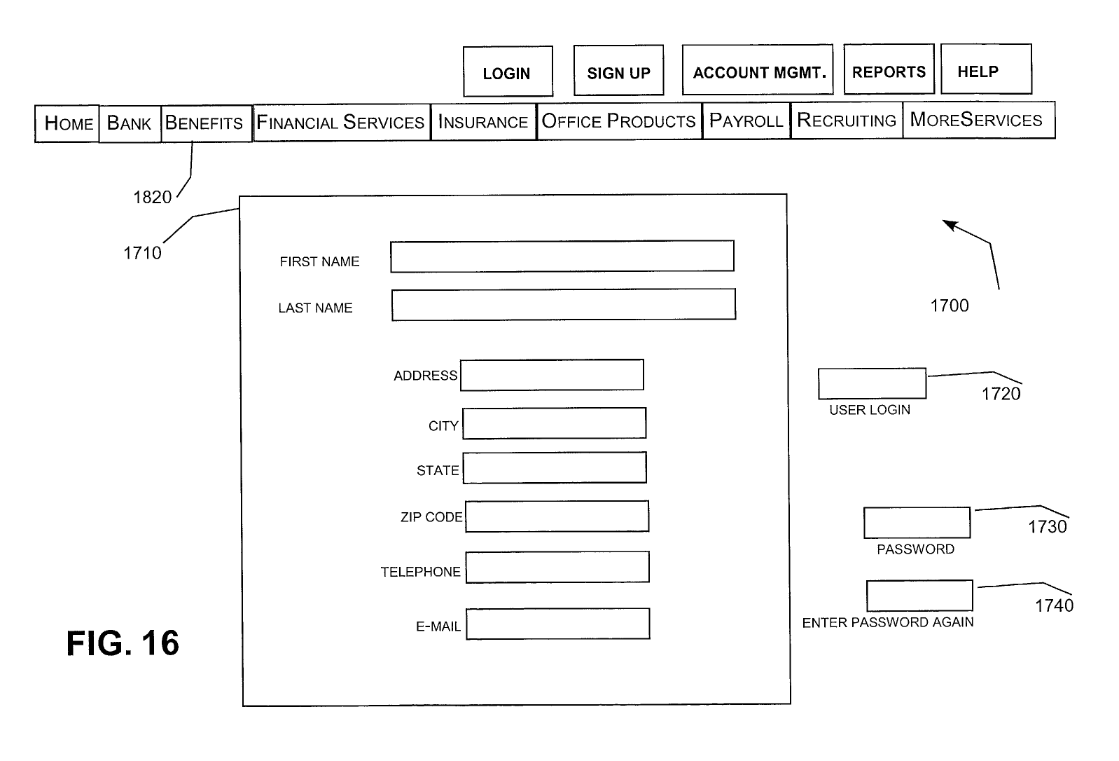

In addition, the login interface 1680 includes a control item for creating a new account 1650. Upon selecting item 1650, the hub application 56 generates a signup interface 1700, shown on FIG. 16.

Turning to FIG. 16, interface 1700 includes various dialog boxes for entering name 1710, a username 1720 to be used to login at dialog box 1610, dialog boxes for creating 1730 and verifying the created password 1740 to be entered into dialog box 1620, and other personal information required to establish an hub account during registration. Such interfaces are common for registration at many Internet sites and are familiar to many Internet users.

Returning to FIG. 15, the interface 1680 also includes a row of control item tabs 1660. These control item tabs 1660 are associated with links that correspond to the links associated with the control items in the affiliate 1530 section that are part of interface 1500 shown on FIG. 14. These same tabs are also part of interface 1700 on FIG. 16. Thus, selecting the tab 1820, as shown on FIGS. 15, 16 and 17, which will be discussed momentarily, directs a client 20 to the same bank affiliate 30 as selecting the control item 1510 shown on FIG. 14.

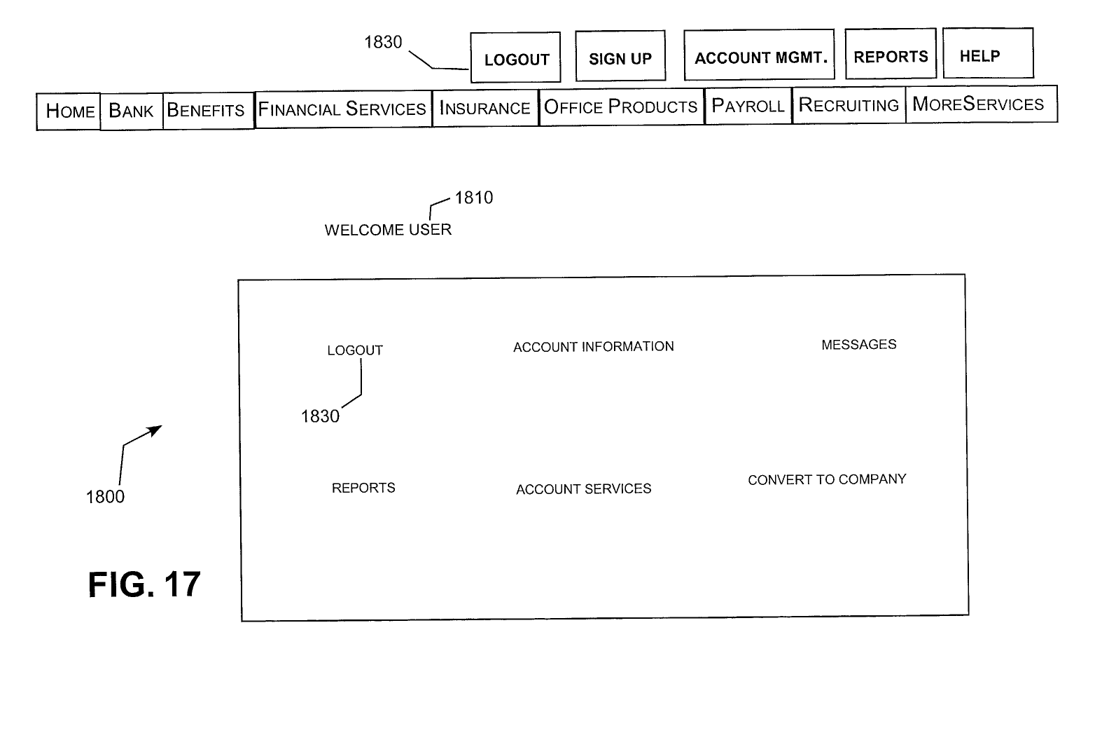

Also shown in FIG. 15, control item 1520 provides a link that directs a client 20 to the login interface 1680. Control item 1520 is unnecessary for the interface shown on FIG. 15 because interface 1680 is the interface that selection of control item 1520 leads to. However, control item 1520 is shown because it is a member of a group of tabs that appear on other interfaces as well. Some examples of these interfaces are illustrated on FIG. 16 and 17.

Turning now to FIG. 17, the figure illustrates a user interface 1800. Interface 1800 displays a welcome screen after the user 21 credentials have been verified and a hub session token 130 has been placed on a client PC 20 at steps 1210 and 1220 respectively, as shown on FIG. 4B. The name of the user 21, as entered into the hub 10 via name dialog box section 1710 shown on FIG. 12, appears as item 1810 on FIG. 17. Finally, selecting control item 1830 allows a user 21 to terminate the client 20 session with the hub 10. Selecting item 1830 cancels the hub session token 130. Doing so prevents future access to an affiliate 30 until a new hub session is established between the client 20 and the hub. Thus, when a client has completed one or multiple transactions with vendors that have affiliate 30 web sites accessible using the ULA system 100, a user 21 can be assured that another user cannot access gain unauthorized access to the first user's affiliate accounts.

In view of the foregoing, it will be appreciated that the invention provides an advantageous unified login and authentication system. It should be understood that the foregoing relates only to the illustrated embodiments of the invention, and that numerous changes may be made therein without departing from the spirit and scope of the invention as defined by the following claims.

What is claimed is:

1. A system for authenticating a client before granting access to a resource over a network comprising:
means for generating a first message and a second message, wherein the first message and second message include a user UID;
means for sending the first message and the second message separately to an affiliate;
means for receiving the first message and the second message; and
means for comparing the credentials from one message to the credentials of the second message to determine whether to authenticate the client.

2. The system of claim 1 wherein the messages are sent to the affiliate via a backend connection of the hub.

3. The system of claim 2 wherein the backend connection of the hub comprises an active socket that will not respond to a message unless the hub expected to receive the message.

4. The system of claim 2 wherein the hub comprises means for using digital certificates to send and receive messages along the backend connection.

5. The system of claim 1 wherein the first message is an XML message further comprising:
a random number;
a user ID encrypted with a first key;
a second key; and
a timeout instruction.

6. The system of claim 5 wherein the second message further comprises:
the random number; and
an intermediate data packet encrypted with the second key, wherein the intermediate data packet further comprises the first key and the user UID.

7. The system of claim 6 wherein the user UID has been hashed to form a hashed user UID.

8. The system of claim 1, wherein a token is used to establish a session between the hub and the client.

9. A system for accessing a plurality of affiliates over a computer network comprising:
a plurality of affiliate applications, wherein each of the plurality of affiliate applications includes,
a) a server computing means,
b) means for XML listening,
c) means for secure communications,
d) means for encrypting and decrypting identification messages; and
a hub, wherein the hub includes,
e) a means for generating a user interface,
f) a client database for associating a plurality of clients with each respective client's sequential UID and login credentials,
g) an affiliate database for associating a plurality of affiliates with a cipher type, a hash type, a backend address and a front-end address for each respective affiliate,
h) means for generating an encrypted client identification,
i) means for secure XML messaging with a plurality of affiliates, and
j) means for redirecting a client browser to one of a plurality of affiliates.

10. A method for accessing a plurality of affiliate nodes comprising the steps of:
receiving a log-in request;
establishing a session token upon successful login;
generating a first encrypted hub UID using a first secure random key;
sending a first message to said one of the plurality of affiliates nodes, the first message including a first encrypted hub UID, a random number, a second secure random key and a timeout instruction;
generating a first hashed hub UID;
generating an encrypted intermediate data packet, wherein the intermediate data packet includes the first hashed hub UID and the first secure random key; and
sending a second message to said one of the plurality of affiliate nodes, wherein the second message includes the random number and the encrypted intermediate data packet.

11. A method for authenticating access to an affiliate comprising:
receiving an access request;
receiving a first message, wherein the first message includes a first encrypted hub UID, a random number, a second secure random key and a timeout instruction;
receiving a second message, wherein the second message includes a random number and an encrypted intermediate data packet;
retrieving the first message, wherein the random number of the first message corresponds to the random number of the second message;
verifying that the timeout instruction has not expired;
decrypting the intermediate data packet using the second secure random key from the first message;
decrypting the hub UID from the first message using the first secure random key decrypted from the intermediate data packet;
hashing the hub UID decrypted from the first message;
comparing the hashed hub UID from the first message to the hashed hub UID from the second message; and
granting access, wherein granting access comprises establishing a session token.

12. A method for accessing an affiliate comprising:
receiving a user interface from a hub;
establishing login credentials with the hub,
entering the login credentials to gain access to one or more affiliates;
receiving a token that establishes a session with a hub; and
receiving a token that establishes a session with an affiliate.

13. A method for accessing one or more of a plurality of affiliates comprising:
attempting to access a secure resource of one of the affiliates;
following a redirection instruction to a hub;
receiving a user interface from a hub;
entering the login credentials to gain access to one or more of the affiliates;
receiving a token that establishes a session with a hub; and
receiving a token that establishes a session with an affiliate.
